(19) United States
(12) Patent Application Publication
(10) Pub. No.: US 2024/0430534 A1
(43) Pub. Date: Dec. 26, 2024

(54) VIDEO PLAYBACK METHOD AND APPARATUS, ELECTRONIC DEVICE, AND STORAGE MEDIUM

(71) Applicant: Tencent Technology (Shenzhen) Company Limited, Shenzhen (CN)

(72) Inventor: Zhenwei ZHANG, Shenzhen (CN)

(73) Assignee: Tencent Technology (Shenzhen) Company Limited, Shenzhen (CN)

(21) Appl. No.: 18/826,665

(22) Filed: Sep. 6, 2024

Related U.S. Application Data
(63) Continuation of application No. PCT/CN2023/090019, filed on Apr. 23, 2023.

(30) Foreign Application Priority Data
Nov. 15, 2022 (CN) 202211430397.9

(51) Int. Cl. H04N 21/472; H04N 21/431

(52) U.S. Cl. CPC H04N 21/47217; H04N 21/4312

(57) ABSTRACT

This application relates to the field of Internet technologies, and in particular, to a video playback method and apparatus, an electronic device, and a storage medium, to efficiently play a video required by an object. The method includes: presenting a video interface, the video interface being configured for displaying at least one piece of video content; presenting at least one recognized recognition object in an operation management area of the video interface in response to an object recognition operation triggered for the at least one piece of video content, each recognition object corresponding to one video clip, each video clip being a clip captured from the corresponding video content and having environmental background information removed and the corresponding recognition object retained; and playing at least one video clip in the operation management area according to a set of playback rules.

### RELATED APPLICATION

This application claims priority as a Continuation to PCT/CN2023/090019 filed on Apr. 23, 2023, which claims priority to Chinese Patent Application No. 202211430397.9, entitled “VIDEO PLAYBACK METHOD AND APPARATUS, ELECTRONIC DEVICE, AND STORAGE MEDIUM” and filed with the China National Intellectual Property Administration on Nov. 15, 2022, both of which are incorporated herein by reference.

### FIELD OF THE TECHNOLOGY

This application relates to the field of Internet technologies, and in particular, to a video playback method and apparatus, an electronic device, and a storage medium.

### BACKGROUND OF THE DISCLOSURE

With the research and progress of artificial intelligence technologies, artificial intelligence technologies have been researched and applied to various fields.

As a video-based information propagation manner becomes increasingly popular, various video-related applications have been developed greatly.

Variety shows are used as an example. When browsing variety shows, a viewer sees several favorite actors in several variety shows. It is very complex for the viewer to search different variety shows for actors, and programs of several favorite actors cannot be played together.

### SUMMARY

Exemplary embodiments of this disclosure provide a video playback method, including:
presenting a video interface, the video interface being configured for displaying at least one piece of video content;
presenting at least one recognized recognition object in an operation management area of the video interface in response to an object recognition operation triggered for the at least one piece of video content, each recognition object corresponding to one video clip, each video clip being a video clip captured from the corresponding video content and having environmental background information removed and the corresponding recognition object retained; and
playing at least one video clip in the operation management area according to a set of playback rules.

In some exemplary embodiments, the method further includes:
in response to a swipe operation triggered based on the operation management area, swiping and viewing recognition objects and corresponding video clips in the operation management area.

In some exemplary embodiments, the method further includes:
in response to a position adjustment operation on at least one specified recognition object in the operation management area, updating an arrangement order of the at least one specified recognition object in the operation management area.

In some exemplary embodiments, the method further includes:
in response to a size adjustment operation on at least one specified recognition object in the operation management area, updating display sizes of the at least one specified recognition object and a corresponding video clip in the operation management area.

Exemplary embodiments of this disclosure provide another video playback method, including:
receiving an object recognition request triggered for at least one piece of video content, performing an object recognition on the at least one piece of video content, and acquiring recognition objects matching the object recognition request, the object recognition request being transmitted by a client in response to an object recognition operation triggered for the at least one piece of video content;
capturing video clips with environmental background information removed and the corresponding recognition objects retained in the at least one piece of video content, each recognition object corresponding to one video clip; and
transmitting the recognition objects and the corresponding video clips to the client to enable the client to present at least one recognized recognition object in an operation management area of a video interface, and playing at least one video clip in the operation management area according to a preset playback rule, the video interface being configured for displaying the at least one piece of video content.

Exemplary embodiments of this disclosure provide a video playback apparatus, including:
a first presentation unit, configured to present a video interface, the video interface being configured for displaying at least one piece of video content;
a second presentation unit, configured to present at least one recognized recognition object in an operation management area of the video interface in response to an object recognition operation triggered for the at least one piece of video content, each recognition object corresponding to one video clip, each video clip being a video clip captured from the corresponding video content and having environmental background information removed and the corresponding recognition object retained; and
a playback unit, configured to play at least one video clip in the operation management area according to a set of playback rules.

In some exemplary embodiments, the second presentation unit is further configured to:
present, in the operation management area in response to an object recognition operation triggered based on target video content currently played on the video interface, at least one recognition object recognized based on a current playback picture of the target video content; and
present, in the operation management area in response to an object recognition operation triggered based on the video interface, at least one recognition object recognized based on specified video content, each piece of specified video content being video content that is in a content library associated with the video interface and meets an automatic recognition rule.

Exemplary embodiments of this disclosure provide another video playback apparatus, including:
a recognition unit, configured to: receive an object recognition request triggered for at least one piece of video content, perform an object recognition on the at least one piece of video content, and acquire recognition objects matching the object recognition request, the object recognition request being transmitted by a client in response to an object recognition operation triggered for the at least one piece of video content;
a processing unit, configured to capture video clips with environmental background information removed and the corresponding recognition objects retained in the at least one piece of video content, each recognition object corresponding to one video clip; and
a feedback unit, configured to: transmit the recognition objects and the corresponding video clips to the client to enable the client to present at least one recognized recognition object in an operation management area of a video interface, and play at least one video clip in the operation management area according to a preset playback rule, the video interface being configured for displaying the at least one piece of video content.

Exemplary embodiments of this disclosure provide a computer-readable storage medium, including a computer program, when the computer program is run on an electronic device, the computer program causing the electronic device to perform the operations of any foregoing video playback method.

Exemplary embodiments of this disclosure provide a computer program product, the computer program product including a computer program, the computer program being stored in a computer-readable storage medium, when a processor of the electronic device reads the computer program from the computer-readable storage medium, the processor executing the computer program to cause the electronic device to perform the operations of any foregoing video playback method.

Other features and advantages of this disclosure are described in the following specification, and partially become apparent from the specification or may be learned through implementation of this disclosure. The objectives and other advantages of this disclosure may be realized and obtained by using structures particularly pointed out in the written specification, claims, and accompanying drawings.

### BRIEF DESCRIPTION OF THE DRAWINGS

The accompanying drawings described herein are intended to provide further understanding of this disclosure and constitute a part of this disclosure. Exemplary embodiments of this disclosure and the description thereof are used for explaining this disclosure rather than constituting an inappropriate limitation to this disclosure. In the accompanying drawings:

FIG. 1 is a schematic diagram of an application scenario according to an exemplary embodiment of this disclosure.

FIG. 2 is a schematic diagram of an implementation of a video playback method according to an exemplary embodiment of this disclosure.

FIG. 3 is a schematic diagram of a video interface according to an exemplary embodiment of this disclosure.

FIG. 4A is a schematic diagram of an authorization interface according to an exemplary embodiment of this disclosure.

FIG. 4B is a schematic diagram of an authorization and interaction process between a client and a server according to an exemplary embodiment of this disclosure.

FIG. 5A is a schematic diagram of a first object recognition manner according to an exemplary embodiment of this disclosure.

FIG. 5B is a schematic diagram of a second object recognition manner according to an exemplary embodiment of this disclosure.

FIG. 6 is a schematic diagram of a scan prompt according to an exemplary embodiment of this disclosure.

FIG. 7 is a schematic diagram of identifier information according to an exemplary embodiment of this disclosure.

FIG. 8A is a schematic diagram of an animation effect according to an exemplary embodiment of this disclosure.

FIG. 8B is a schematic diagram of an operation management area according to an exemplary embodiment of this disclosure.

FIG. 9A is a schematic diagram of a recognition object display effect according to an exemplary embodiment of this disclosure.

FIG. 9B is a schematic diagram of another recognition object display effect according to an exemplary embodiment of this disclosure.

FIG. 10A is a schematic diagram of a third object recognition manner according to an exemplary embodiment of this disclosure.

FIG. 10B is a schematic diagram of a fourth object recognition manner according to an exemplary embodiment of this disclosure.

FIG. 11A is a schematic diagram of another scan prompt according to an exemplary embodiment of this disclosure.

FIG. 11B is a schematic diagram of other identifier information according to an exemplary embodiment of this disclosure.

FIG. 11C is a schematic diagram of another animation effect according to an exemplary embodiment of this disclosure.

FIG. 11D is a schematic diagram of a first video interface and an operation management area according to an exemplary embodiment of this disclosure.

FIG. 11E is a schematic diagram of a second video interface and an operation management area according to an exemplary embodiment of this disclosure.

FIG. 11F is a schematic diagram of a third video interface and an operation management area according to an exemplary embodiment of this disclosure.

FIG. 12 is a schematic diagram of an automatic pick manner according to an exemplary embodiment of this disclosure.

FIG. 13 is a schematic diagram of a setting manner of an automatic recognition rule according to an exemplary embodiment of this disclosure.

FIG. 14 is a schematic diagram of an expansion process of an operation management area according to an exemplary embodiment of this disclosure.

FIG. 15A is a schematic diagram of a playback setting manner according to an exemplary embodiment of this disclosure.

FIG. 15B is a schematic diagram of another playback setting manner according to an exemplary embodiment of this disclosure.

FIG. 16 is a schematic diagram of a layout style of an operation dock according to an exemplary embodiment of this disclosure.

FIG. 17 is a schematic diagram of an operation control according to an exemplary embodiment of this disclosure.

FIG. 18 is a schematic diagram of a program return operation according to an exemplary embodiment of this disclosure.

FIG. 19 is a schematic diagram of a collection process according to an exemplary embodiment of this disclosure.

FIG. 20 is a schematic diagram of a collection interface according to an exemplary embodiment of this disclosure.

FIG. 21 is a schematic diagram of another program return operation according to an exemplary embodiment of this disclosure.

FIG. 22 is a schematic diagram of a swipe process according to an exemplary embodiment of this disclosure.

FIG. 23A is a schematic diagram of an object position adjustment according to an exemplary embodiment of this disclosure.

FIG. 23B is a schematic diagram of another object position adjustment according to an exemplary embodiment of this disclosure.

FIG. 24 is a schematic diagram of a display size adjustment according to an exemplary embodiment of this disclosure.

FIG. 25 is a schematic diagram of another implementation of a video playback method according to an exemplary embodiment of this disclosure.

FIG. 26 is a schematic diagram of a face recognition procedure according to an exemplary embodiment of this disclosure.

FIG. 27 is a schematic diagram of a procedure of processing and playing video content according to an exemplary embodiment of this disclosure.

FIG. 28 is a schematic diagram of an interaction process of automatically recognizing an actor according to an exemplary embodiment of this disclosure.

FIG. 29 is a schematic diagram of a procedure of returning to an original program through a selected actor according to an exemplary embodiment of this disclosure.

FIG. 30 is a schematic diagram of an authorization and interaction process of a single actor between a client and a server according to an exemplary embodiment of this disclosure.

FIG. 31 is a schematic diagram of a recognition and interaction process of a plurality of actors between a client and a server according to an exemplary embodiment of this disclosure.

FIG. 32 is a schematic structural diagram of a video playback apparatus according to an exemplary embodiment of this disclosure.

FIG. 33 is a schematic structural diagram of another video playback apparatus according to an exemplary embodiment of this disclosure.

FIG. 34 is a schematic structural diagram of hardware in which an electronic device according to an exemplary embodiment of this disclosure is used.

FIG. 35 is a schematic structural diagram of hardware in which another electronic device according to an exemplary embodiment of this disclosure is used.

### DESCRIPTION OF EMBODIMENTS

To make the objectives, technical solutions, and advantages of the exemplary embodiments of this disclosure clearer, the technical solutions in this disclosure will be clearly and completely described in the following with reference to the accompanying drawings in the exemplary embodiments of this disclosure. Apparently, the described exemplary embodiments are merely a part rather than all of the embodiments of the technical solutions of this disclosure. All other exemplary embodiments obtained by a person of ordinary skill in the art based on the exemplary embodiments recorded in the document of this disclosure without creative efforts shall fall within the protection scope of the technical solutions of this disclosure.

The following describes some concepts involved in the exemplary embodiments of this disclosure.

Video: Videos generally refer to various technologies that capture, record, process, store, transmit, and reproduce a series of still images in an electrical signal manner. When consecutive image changes exceed more than 24 frames of pictures per second, according to the principle of persistent vision, human eyes cannot discern single still pictures. It appears as a smooth continuous visual effect. Such continuous pictures are called a video.

Long video: A long video is generally a video lasting more than half an hour, and is mainly a variety show, a movie, a TV series, or the like, distinguished from a small video (also referred to as a short video) lasting 15 seconds or the like.

In this disclosure, there are mainly two categories of videos: video content and a video clip. The video content is a video posted and played on a video platform, and may be a variety show, a movie, a TV series, an animation film, or the like. The video clip is a clip captured from the video content. In this disclosure, the captured video clip is a clip with environmental background information (which are other information such as stage background information different from a recognition object) removed and only information such as some images, audio, and videos of a corresponding recognition object retained.

Actor: An actor is a performer playing a character in performing arts, or a professional participating in a performance such as a theater, a drama, a movie, a TV series, a dance, or a music. Generally, some public figures in a video program have high social recognition and have many works of art such as songs and dances. A program is a relatively complete piece of content performed by an actor, including, but not limited to, a song, a dance, or the like.

Operation management area (also referred to as an operation dock): Similar to a program dock, an operation management area is an area that temporarily or permanently stores an operation, and may be in a floating state, a fixed state, or the like, and a plurality of management operations may be performed on content or a program in the area. In the exemplary embodiments of this disclosure, in the operation management area, one or more recognition objects may be displayed, and a video clip corresponding to the recognition object is played. In addition, some specified operations such as playing a video clip, pausing a video clip, collecting, sharing, and returning to a program may be performed on the one or more recognition objects based on the operation management area.

In this disclosure, the returning to a program is short for returning to an original program. If a program return operation is performed on a recognition object or a corresponding video clip, it means jumping back to video content to which the corresponding video clip of the recognition object belongs for playback. The video content to which the video clip belongs is original video content from which the video clip is captured.

Automatic recognition rule: An automatic recognition rule is a rule for configuring how a system automatically recognizes an object from video content. The automatic recognition rule may be a default rule of the system, or may be set by a viewer as required, and includes, but is not limited to, a name of an object to be recognized, a performance type, a program name, and a time range.

Playback rule: A playback rule is a rule configured for describing how the video clips corresponding to the recognition objects are to be played in the operation management area, and is, for example, video clips of recognition objects that are to be played, an order in which the video clips are to be played, and a volume of playback.

Identifier information: Identifier information is information configured for identifying a corresponding recognition object in a current playback picture, including, but not limited to, an object contour identification line, object basic information, and program basic information.

Pick: Pick represents a function of quickly obtaining content. Pick is used below to refer to the function.

The following briefly describes the design idea in the exemplary embodiments of this disclosure:

With the research and progress of artificial intelligence technologies, artificial intelligence technologies have been researched and applied to various fields such as common smart homes, smart wearable devices, virtual assistants, smart speakers, smart marketing, driverless driving, self-driving, unmanned aerial vehicles, robots, smart medicine, and smart customer service. It is believed that as the technology develops, the artificial intelligence technology will be applied in more fields and exert increasingly important value.

As a video-based information propagation manner becomes increasingly popular, various video-related applications have been developed greatly.

Long videos such as variety shows are used as an example. When browsing variety shows, a viewer sees several favorite actors in several variety shows. It is very complex for the viewer to search different variety shows for actors, and programs of several favorite actors cannot be played together.

To resolve the foregoing problems, a common processing manner in the related art is to reduce the size of a video player and move the video player to a position, to browse more content during playback. Alternatively, a video is cropped into a video clip according to a character or a requirement.

However, the foregoing two manners have high operation complexity and inconvenient use. In addition, frequent repeated operations of a viewer, for example, frequent cropping of videos, and frequent searches for videos, are required. As a result, playback efficiency is low, and a terminal device is prone to an unnecessary running load, causing a waste of device resources and network resources of the terminal device.

In view of this, exemplary embodiments of this disclosure provide a video playback method and apparatus, an electronic device, and a storage medium. In this disclosure, a viewer may trigger an object recognition operation on video content that has been displayed or that has not been displayed in a video interface. Further, an operation management area is presented in the video interface, at least one recognized recognition object is presented in the area, and a video clip corresponding to each recognition object is played according to a set rule. These video clips are captured from the video content and has environmental background information removed and only information of the corresponding recognition object retained. In this way, the viewer can view clips of one or more favorite recognition objects simultaneously through the operation management area, so that playback efficiency is high. In addition, the video playback method provided in this disclosure is simple to operate. The viewer only needs to trigger an object recognition operation based on at least one piece of video content in the video interface to capture a corresponding video clip and watch the video clip, and neither needs to crop videos nor needs to frequently make searches and repeat the same operation. In this way, the viewer can quickly collect favorite recognition objects and corresponding video clips in a plurality of videos conveniently, which is convenient for the viewer to quickly collect content that the viewer is interested in, and the operation process is simple and straightforward. Therefore, through the technical solutions of the exemplary embodiments of this disclosure, in one aspect, consumption of device resources and network resources caused by a user frequently searching for clips corresponding to recognition objects is avoided. In another aspect, through simple operations, the user can quickly collect favorite recognition objects and corresponding video clips in a plurality of videos conveniently, thereby improving the efficiency of human-computer interaction.

The following describes exemplary embodiments of this disclosure with reference to the accompanying drawings of this specification. The exemplary embodiments described herein are merely used to describe and explain this disclosure, but are not used to limit this disclosure, and the exemplary embodiments and features in the exemplary embodiments of this disclosure may be combined with each other without conflict.

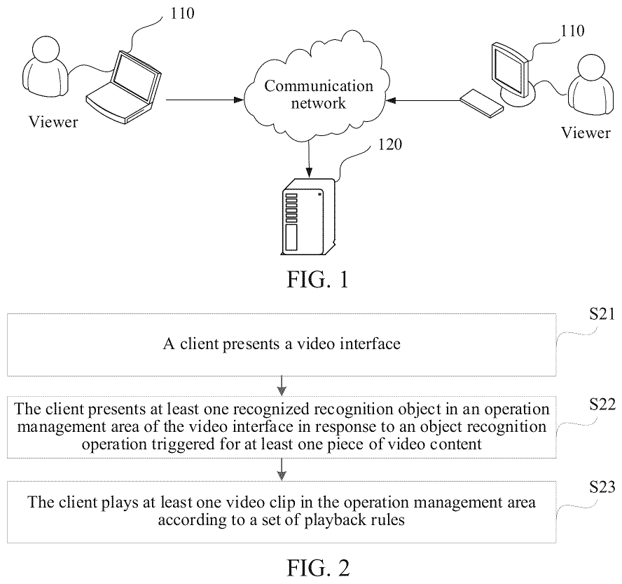

FIG. 1 is a schematic diagram of an application scenario according to an exemplary embodiment of this disclosure. The diagram of the application scenario includes two terminal devices 110 and one server 120.

In the exemplary embodiments of this disclosure, each terminal device 110 includes, but is not limited to, a mobile phone, a tablet computer, a laptop computer, a desktop computer, an electronic book reader, a smart speech interaction device, a smart home appliance, and an in-vehicle terminal. A video-related client may be installed on the terminal device. The client may be software (for example, a browser, or video software), or may be a webpage, an applet, or the like. The server 120 is a backend server corresponding to the software, webpage, applet, or the like, or is a server dedicated for video playback. This is not limited in this disclosure. The server 120 may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

A video playback method in the exemplary embodiments of this disclosure may be performed by an electronic device. The electronic device may be the terminal device 110 or the server 120. To be specific, the method may be separately performed by the terminal device 110 or the server 120, or may be jointly performed by the terminal device 110 and the server 120. An example in which the method is jointly performed by the terminal device 110 and the server 120 is used. A browser may be installed on the terminal device 110. A viewer views a video interface through the browser. The video interface is configured to display one or more pieces of video content. The viewer may trigger an object recognition operation through the video interface. The browser transmits an object recognition request to the server 120 in response to an object recognition operation triggered for at least one piece of video content (video content that has been displayed currently or video content to be displayed in the video interface) by the viewer. The server 120 performs an object recognition on the corresponding video content to acquire recognition objects matching the object recognition request. Further, the server 120 captures video clips with environmental background information removed and the corresponding recognition objects retained in the corresponding video content. Further, the server 120 transmits the recognition objects and the corresponding video clips to the browser. The browser presents at least one recognition object in an operation management area of the video interface. Subsequently, at least one video clip is played in the operation management area according to a set of playback rulesa set of playback rules.

In some exemplary embodiments, the terminal device 110 may communicate with the server 120 through a communication network.

In some exemplary embodiments, the communication network is a wired network or a wireless network.

FIG. 1 merely shows an example for description. In practice, a quantity of terminal devices and a quantity of servers are not limited. This is not specifically limited in the exemplary embodiments of this disclosure.

In the exemplary embodiments of this disclosure, when a plurality of servers are used, the plurality of servers may form a blockchain, and the servers are nodes on the blockchain. For the video playback method disclosed in the exemplary embodiments of this disclosure, related data such as video content, video clips, recognition objects, identifier information, playback rules, and automatic recognition rules may be saved on the blockchain.

In addition, the exemplary embodiments of this disclosure may be applied to various scenarios, including, but not limited to, scenarios such as cloud technologies, artificial intelligence, intelligent transportation, and driver assistance.

The video playback method provided in exemplary implementations of this disclosure is described below in conjunction with the application scenario described above with reference to the accompanying drawings. The foregoing application scenario is described merely for ease of understanding of the spirit and principle of this disclosure, and the implementations of this disclosure are not limited in this aspect.

FIG. 2 is a schematic diagram of an implementation of a video playback method according to an exemplary embodiment of this disclosure. An example in which a video playback-related client installed on a terminal device is an execution entity is used. A specific implementation procedure of the method is S21 to S23 as follows:

S21: The client presents a video interface.

The video interface is configured to display at least one piece of video content. The video interface may be an interface of any video-related client (for example, a long-video content product). The video content that the video interface is configured to display may be video content that has been displayed in a current video interface, or may be video content that has not been displayed in a content library related to the client. A browser client is mainly used as an example herein. Certainly, another client is also applicable, and is not specifically limited.

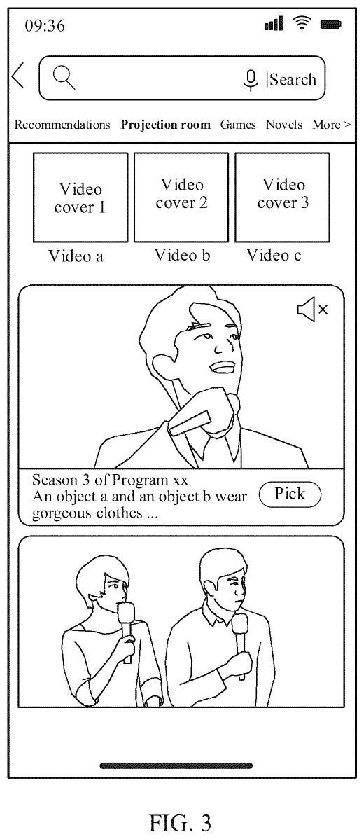

FIG. 3 is a schematic diagram of a video interface according to an exemplary embodiment of this disclosure. An example in which the client is a browser is used herein. The video interface shown in FIG. 3 is a video interface in a “Projection room” option in the browser. A viewer (for example, a browser user) may browse and play video content (also referred to as a video program, a program for short) in the interface.

In the exemplary embodiments of this disclosure, in a process of using the browser, the viewer needs to authorize recognition, recording, analysis, storage, and the like of data such as viewed content and viewing behavior.

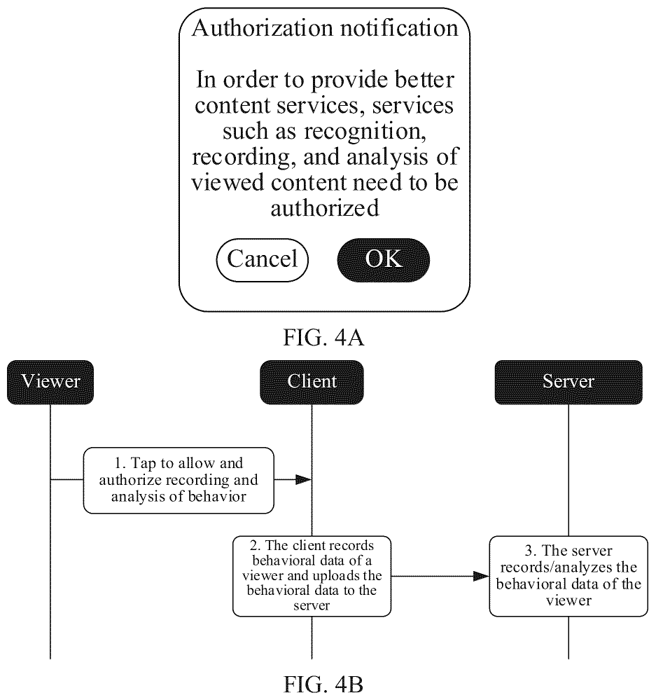

FIG. 4A is a schematic diagram of an authorization interface according to an exemplary embodiment of this disclosure. The authorization interface may be displayed in the video interface in the form of a pop-up window, a floating layer, or the like to prompt the viewer to grant authorization to implement subsequent operations.

If the viewer taps “OK”, authorization is granted to allow recording, analysis, and the like of the behavior of the viewer.

FIG. 4B is a schematic diagram of an authorization and interaction process between a client and a server according to an exemplary embodiment of this disclosure. A specific interaction process is as follows:

1. The viewer taps to allow and authorize recording and analysis of the behavior of the viewer.

2. The client records behavioral data of the viewer and uploads the behavioral data to the server.

3. The server records/analyzes the behavioral data of the viewer.

As listed subsequently, when the viewer triggers an object recognition request, the client may record data related to the behavior of the viewer and upload the data to the server, to recognize related video content through the server. In another example, when a program return operation is triggered for an object, the client may record data related to the behavior of the viewer and upload the data to the server, to analyze a corresponding playback position through the server and feed back the playback position to the client.

In specific implementations of this disclosure, related data such as user information and behavior are involved. When the foregoing exemplary embodiments of this disclosure are used in specific products or technologies, user permissions or agreements need to be obtained, and the collection, use, and processing of relevant data need to comply with the relevant laws, regulations, and standards of the relevant countries and regions.

S22: The client presents at least one recognized recognition object in an operation management area of the video interface in response to an object recognition operation triggered for at least one piece of video content.

Each recognition object corresponds to one video clip. The recognition object may be a person or may be a virtual character (for example, a cartoon character or a personified character) or another living or lifelike object; or may be a still object (for example, an xx school), a place, scenery, or another lifeless object. Details are not described herein again. A person (for example, an actor) is mainly used as an example herein. The video clip is a clip that is captured from corresponding video content and corresponds to the person. Subsequently, an actor is used to represent a main person to be recognized in a video.

Specifically, each video clip may include only one recognition object (for example, an actor) or may include a plurality of recognition objects (for example, a couple, or a singing and dancing group).

Each video clip is a clip captured from the corresponding video content and having environmental background information removed and the corresponding recognition object retained. The corresponding video content is video content including a target object. The target object is an object that needs to be recognized from the video content. For example, the target object may be an actor in which the viewer is interested in the video content.

In this disclosure, after the environmental background information is removed, only information such as all images, videos, and audio of the recognition object are retained in an obtained video clip. Therefore, the video clip may be a video clip that displays only a transparent bottom of the recognition object and may be stored as a video file with a transparent channel.

Therefore, the presenting the recognition object in the operation management area in the video interface is equivalent to presenting a video clip corresponding to the recognition object.

In addition, the video clip is captured from the corresponding video content, and includes, but is not limited to, a fixed video clip (for example, a video clip that starts from a triggering moment of the object recognition operation and only includes the corresponding recognition object) or an intelligently recognized video clip (for example, a song or a dance) of a complete program.

In this disclosure, during the implementation of Operation S22, the object recognition operation may be triggered in a plurality of manners. For example, according to a requirement of recognizing video content, the manners include a recognition of target video content currently played in the video interface, a recognition of some video content in a content library associated with the video interface, or the like. The target video content may also be referred to as first video content, and is video content currently played in the video interface.

Based on this, the manners may be categorized into the following two triggering and presentation manners:

Manner 1: The client presents, in the operation management area in response to an object recognition operation triggered for the target video content currently played on the video interface, at least one recognition object recognized from a current playback picture of the target video content.

The foregoing Manner 1 represents that in a process in which the viewer plays video content (i.e., the target video content) in the current video interface, the object recognition operation for the target video content may be triggered, and at least one recognition object recognized based on the current playback picture of the target video content is displayed in the operation management area.

For example, during the playback of a variety show, if the viewer sees an actor in which the viewer is interested, the object recognition operation on the target video content may be triggered to recognize the actor in the current playback picture.

Based on this, according to different triggering mechanisms, the following cases may be included:

Case 1: The object recognition operation is performed in response to a preset operation performed on a target object in the current playback picture, and the recognized recognition object is presented in the operation management area. The target object includes an object that is selected by the viewer as required and needs to be recognized from the video content.

The preset operation may be a long press, a tap, a preset gesture, a preset speech instruction, or the like, and is not specifically limited herein.

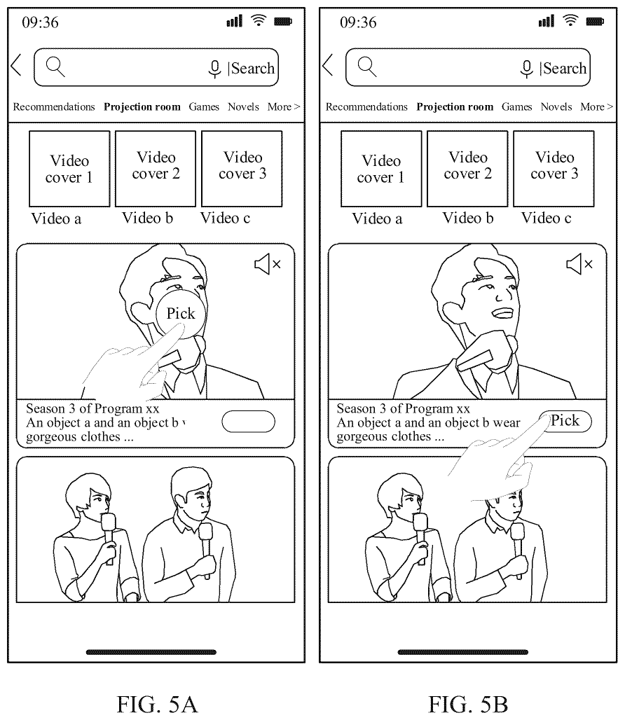

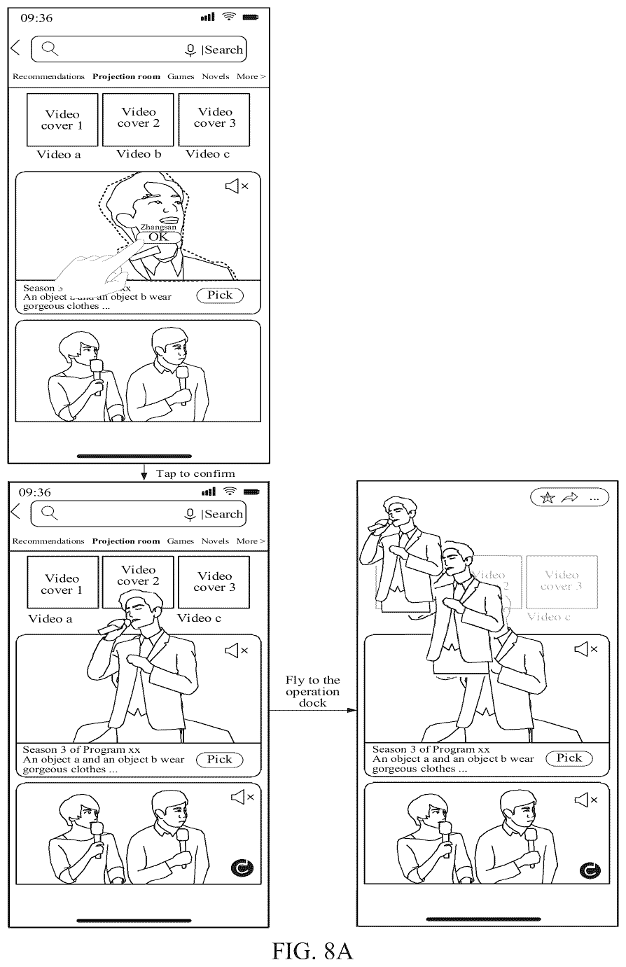

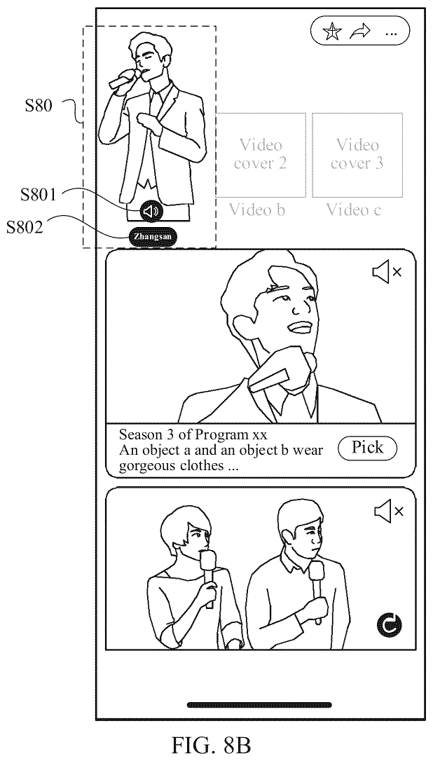

A long press is used as an example. FIG. 5A is a schematic diagram of a first object recognition manner according to an exemplary embodiment of this application. Video content “Season 3 of Program xx, Object a and Object b . . . ”, i.e., the target video content, is played in the current video interface. When the viewer sees an actor that the viewer likes in the current playback picture, the viewer may perform a long press operation at a position of the actor (i.e., the target object) on a screen to trigger the object recognition operation for the current playback picture of the video program. Further, the actor is presented in the operation management area, as shown in FIG. 8B. Only a simple example is provided here, and detailed description is provided below.

Case 2: The object recognition operation is performed in response to a triggering operation on a picture recognition control at a related position of the target video content, and the at least one recognition object is presented in the current playback picture in the operation management area.

The related position may be an upper position, a lower position, a left position, a right position, or the like of the target video content. A right side of a program name of the target video content is used as an example herein. For example, a “Pick” button in FIG. 5B is a picture recognition control listed in this disclosure.

FIG. 5B is a schematic diagram of a second object recognition manner according to an exemplary embodiment of this disclosure. Video content “Season 3 of Program xx, Object a and Object b . . . ”, i.e., the target video content, is played in the current video interface. When the viewer sees an actor that the viewer likes in the current playback picture, the viewer may tap the “Pick” button shown in FIG. 5B to trigger the object recognition operation for the current playback picture of the video program. Further, the actor is presented in the operation management area, as shown in FIG. 8B.

The several mechanisms of triggering an object recognition for the current playback picture of the target video content listed above are only examples for description. Any object recognition manner based on the current playback picture of the target video content is applicable to the exemplary embodiments of this disclosure. Details are not described herein again.

In some exemplary embodiments, it is considered that the object recognition operation triggered based on the target video content currently played on the video interface is used in Manner 1, in other words, in a case that the viewer uses Manner 1, the viewer tends to view a recognition object from the target video content. Based on this, in response to the object recognition operation triggered for the target video content currently played on the video interface, instead of directly presenting the operation management area or directly presenting the recognition object in the operation management area, the following operations may be performed first:
pausing playback of the target video content in the video interface, and presenting identifier information of recognized recognition objects in the current playback picture.

For example, the viewer watches the target video content being played in the current video interface and triggers the object recognition operation in the current playback picture in the manner shown in FIG. 5A or FIG. 5B. Further, the browser pauses playback of the target video content in response to the operation, and starts to intelligently recognize an object on the screen.

In this disclosure, during the intelligent recognition of an object on the screen, an overall picture may be scanned and recognized. In this case, the client may further make a scan prompt to the viewer to prompt a user to enter a scanning and recognition process.

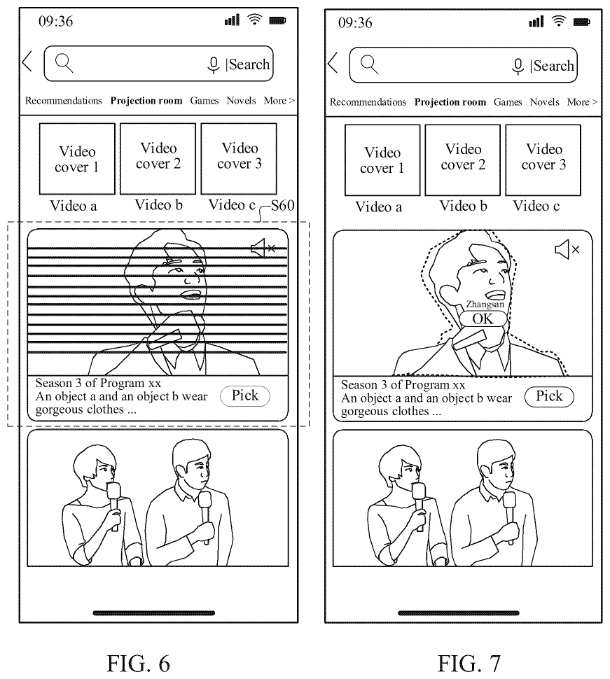

FIG. 6 is a schematic diagram of a scan prompt according to an exemplary embodiment of this disclosure. An area S60 in FIG. 6 is the current playback picture of the target video content currently played. In a case that the viewer long presses or taps the picture recognition control, for example, “Pick” in FIG. 6, to trigger the object recognition operation, the playback may be paused, and the current playback picture is scanned. A person, i.e., a recognition object, exists in the current playback picture. Compared with FIG. 5A or FIG. 5B, bold horizontal lines marked for the part of the person represent scanning lines (or colored scanning lines may be used), which is a scan prompt manner in this disclosure. Only a simple example is provided here. A manner of the scan prompt is not specifically limited herein.

After the scan ends, identifier information of recognized objects (i.e., recognition objects) may be presented in the current playback picture.

The identifier information includes, but is not limited to, at least one of the following:
an object contour identification line, object basic information (for example, a name and a gender), and program basic information (for example, a program name).

An object contour identification line and an object name are mainly used as an example herein. FIG. 7 is a schematic diagram of identifier information according to an exemplary embodiment of this disclosure. In FIG. 7, a contour of a recognition object is marked with a dashed line box, and it is prompted that a name of the object is “Zhangsan”. In addition, an “OK” button is further displayed. The viewer analyzes, through a recognized dashed line box, person basic information, and the like, whether a recognition result is accurate to select whether to make a confirmation. After confirming that the picked object is accurate, an “OK” operation on the recognition object may be triggered.

In the foregoing implementation, the viewer may be prompted through the identifier information to check whether a recognized object is an object that the viewer wants to view. Based on this, the viewer may further confirm a recognition object to select the recognition object, and display the recognition object in the operation management area, thereby ensuring the accuracy of the recognition result.

In a confirmation manner provided in some exemplary embodiments of this disclosure, based on presenting the identifier information of the recognized recognition objects in the current playback picture, the client presents, in response to confirmation operations on the recognized recognition objects, animation effects of the recognition objects flying to the operation management area respectively, and displays the recognition objects in the operation management area.

In this disclosure, the operation management area may also be referred to as an operation dock, and is an area that is similar to a program dock and may temporarily or permanently store an operation, and may be in a floating state, a fixed state, or the like. In the exemplary embodiments of this disclosure, for example, the operation management area floats above the video interface.

Specifically, the operation management area may be in a translucent form, an opaque form, or the like. This is not specifically limited herein.

For example, after confirming an actor, the viewer may remove an environmental background of the actor and retain all image, video, and audio information of the person, and the selected actor simultaneously moves to the operation management area at the top of the interface, for example, flies into the operation management area at the top of the interface.

In the exemplary embodiments of this disclosure, video content may be recognized by the client, or the client may indicate the server to perform a recognition and feed back a recognition result, for example, a recognition object, a corresponding video clip, and identifier information. This is not specifically limited herein.

In a process of moving the recognition object to the operation management area, the recognition object may remain unchanged or may change dynamically. For example, the video clip of the recognition object is played in the process, to implement simultaneous movement and playback of the video clip (i.e., the recognition object with a transparent bottom).

FIG. 8A is a schematic diagram of an animation effect according to an exemplary embodiment of this disclosure. In FIG. 8A, for example, the form of the recognition object remains unchanged in the process of the recognition object moving to the operation management area. As a selected actor, the recognition object gradually moves to the operation management area at the top of the interface. In the process of moving to the operation management area, the form of the recognition object remains unchanged. However, the display effect is that the person gradually becomes smaller in the process of moving from the target video content to the operation management area. Certainly, another animation effect may be used. This is not specifically limited herein.

FIG. 8B is a schematic diagram of an operation management area according to an exemplary embodiment of this disclosure. The operation management area listed in FIG. 8B is displayed at the top of the video interface in the form of a translucent floating layer, or certainly may be displayed at another position, for example, a bottom of the video interface. This is not specifically limited herein. S80 in the operation management area is the recognized “Zhangsan”.

A presentation manner of the recognition object may be a playable video clip. For example, a current sound playback state of the video clip corresponding to the recognition object is further displayed in S80. S801 represents a non-muted state. S802 represents a name of the recognition object. In addition, a playback button, a pause button, and the like may be further displayed. This is not specifically limited herein.

In FIG. 8A, FIG. 8B, and subsequent schematic diagrams related to the operation management area, some information that is not related to the operation management area is omitted, but it does not represent that such information is not displayed. Information that is supposed to be displayed still needs to be displayed in an actual interface. Only a simple example for highlighting the operation management area is provided herein.

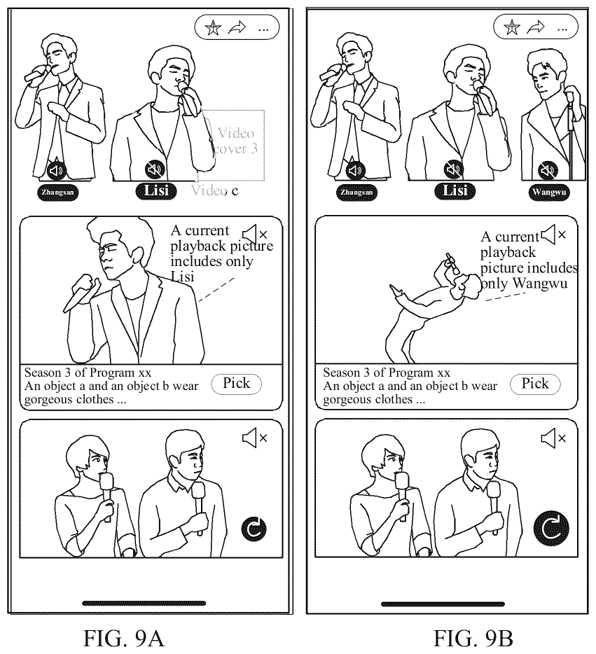

Based on the foregoing manner, the viewer may select a favorite actor from a program. Based on this, the viewer may continue to select a favorite actor from a next program or from another time point in the current program. The selected actor flies into the operation management area. FIG. 9A is a schematic diagram of a recognition object display effect according to an exemplary embodiment of this disclosure. FIG. 9A represents that the viewer further picks a favorite actor “Lisi” from another time point in the current program. To be specific, “Lisi” is displayed after “Zhangsan” in the operation management area. Further, the viewer may further continue to select a favorite actor from another time point of the current program or a next program. FIG. 9B is a schematic diagram of another recognition object display effect according to an exemplary embodiment of this disclosure. Assuming that the viewer continues to select “Wangwu”, “Wangwu” may be further displayed following “Lisi” in the operation management area.

In a case that the operation management area displays a plurality of recognition objects, a horizontal arrangement display manner listed in FIG. 9A and FIG. 9B may be used, or another arrangement manner, for example, a vertical arrangement manner, may be used. In addition, these recognition objects may be displayed according to a recognition order, or may be displayed according to a name order, or displayed according to an order of durations of corresponding video clips, or displayed according to an order of liking degrees of the viewer. This is not specifically limited herein.

In the examples listed in FIG. 5A to FIG. 9B above, only a case that the current playback picture includes one recognition object (actor) is listed. Certainly, when the current playback picture includes a plurality of actors, the video playback method in this disclosure is also applicable. An example in which the current playback picture includes three actors is used for description below.

In a case that the picture includes a plurality of actors, according to different triggering mechanisms, two cases listed below may be included:

Case 3: The object recognition operation is performed in response to a preset operation performed on a target object in the current playback picture, and the recognized recognition object is presented in the operation management area.

For example, the viewer may tap actors in the picture to select specific actors. The logic of the selection is consistent with the recognition of a single actor listed in the related part of Case 1 above. Recognized actors enter the operation management area for display.

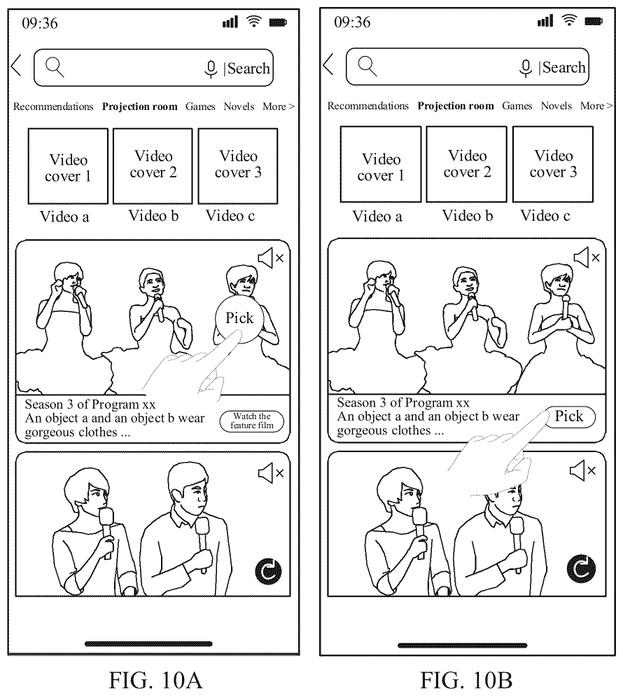

FIG. 10A is a schematic diagram of a third object recognition manner according to an embodiment of this disclosure. A long press is used as an example. Video content “Season 3 of Program xx, Object a and Object b . . . ”, i.e., the target video content, is played in the current video interface. When the viewer sees an actor that the viewer likes in the current playback picture, the viewer may long press a position of the actor (i.e., the target object) on a screen to trigger the object recognition operation for the current playback picture of the video program.

Case 4: The object recognition operation is performed in response to a triggering operation on a picture recognition control at a related position of the target video content, and the at least one recognition object is presented in the current playback picture in the operation management area.

For example, the viewer taps the Pick button, the overall picture is scanned and recognized, and it may be recognized that one picture has a plurality of actors.

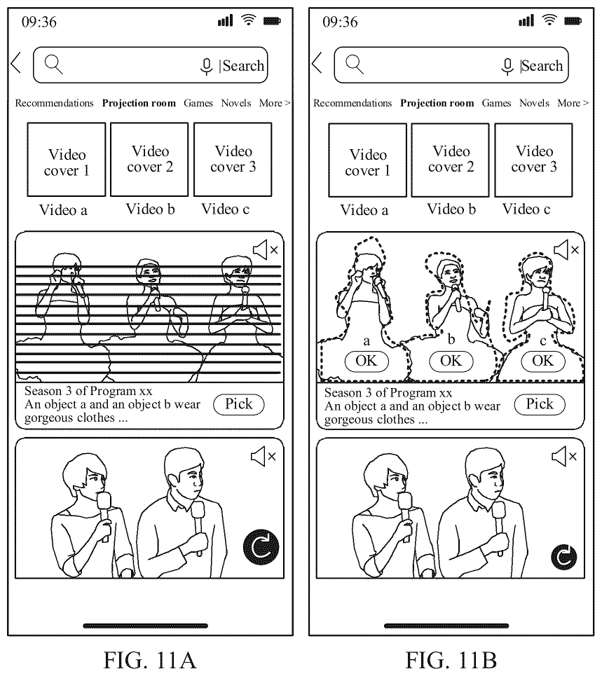

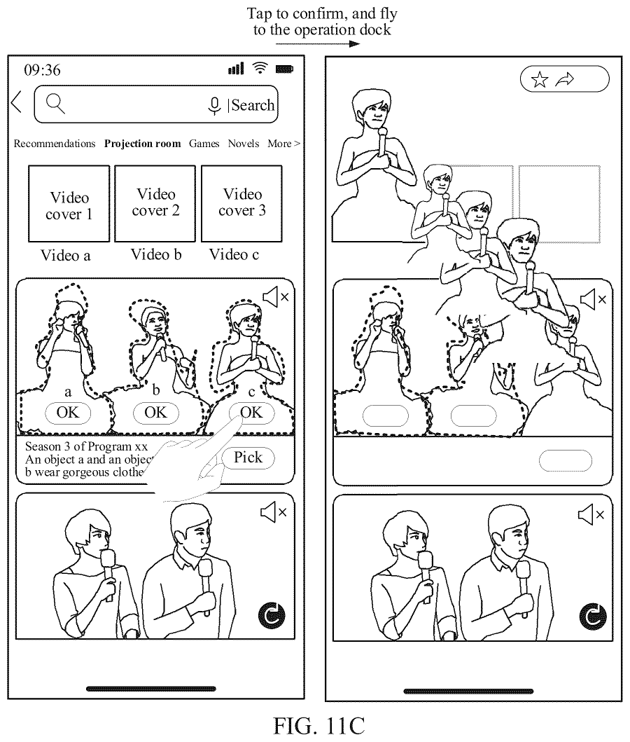

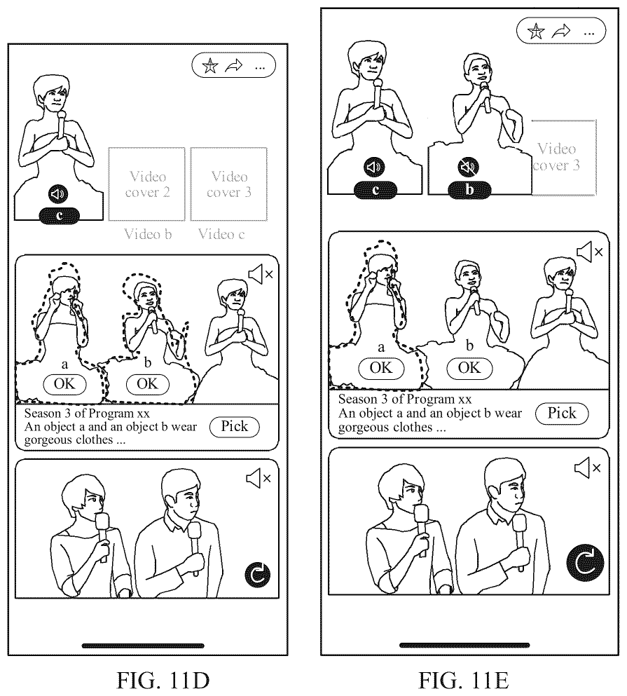

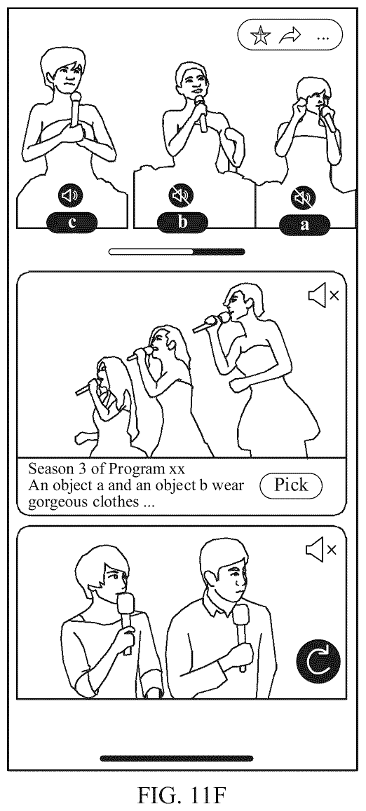

FIG. 10B is a schematic diagram of a fourth object recognition manner according to an exemplary embodiment of this disclosure. When the viewer sees an actor that the viewer likes in the current playback picture, the viewer may perform a tap operation on the “Pick” button shown in FIG. 11B to trigger the object recognition operation for the current playback picture of the video program.

In a recognition process, a scanning line may be configured for a scan prompt. FIG. 11A is a schematic diagram of another scan prompt according to an exemplary embodiment of this disclosure. An area S110 in FIG. 11A is the current playback picture of the target video content currently played. In a case that the viewer long presses or taps “Pick” or the like to trigger the object recognition operation, the playback may be paused, and the current playback picture is scanned. The current playback picture has three people, i.e., three first recognition objects (target objects), and bold horizontal lines (scanning lines) are used to provide a scan prompt for the viewer.

Recognized actors are identified, and the viewer may perform a secondary confirmation to determine whether to select the identified actors.

FIG. 11B is a schematic diagram of other identifier information according to an exemplary embodiment of this disclosure. In FIG. 11B, contours of the three recognition objects are marked with dashed line boxes, and it is prompted that respective names of the objects are “a”, “b”, and “c”. In addition, three “OK” buttons are further displayed.

FIG. 11C is a schematic diagram of another animation effect according to an exemplary embodiment of this disclosure. The viewer selects an actor “c”, and the actor slowly flows into the operation management area, to present an interface shown in FIG. 11D, which is a schematic diagram of a first video interface and an operation management area according to an exemplary embodiment of this disclosure. The operation management area is presented at the top of the video interface, and the recognition object “c” is presented in the area. Same as the foregoing related description, a presentation manner of the recognition object may be a playable video clip. Therefore, a current sound playback state of the video clip corresponding to the recognition object is displayed in the operation management area. FIG. 11D represents a non-muted state.

In FIG. 11D, a contour identification line of the confirmed recognition object “c” is no longer displayed.

Further, performance in an original program is played, and the viewer may continue to select another recognized actor. After a tap for confirmation, the another recognized actor is moved to the operation management area to play a corresponding video clip.

The viewer continues to select an actor “b”, and the actor is moved into the operation management area and is displayed following “c”. FIG. 11E shows a second video interface and an operation management area according to an exemplary embodiment of this disclosure. A current sound playback state of a video clip corresponding to “b” is represented as a muted state.

The viewer continues to select an actor “a”, and the actor is also moved into the operation management area and is displayed following “b”. FIG. 11F shows a third video interface and an operation management area according to an exemplary embodiment of this disclosure. A current sound playback state of a video clip corresponding to “a” is also represented as a muted state.

Based on the foregoing implementation, the viewer may select one or more actors from one picture to enter the operation management area, and the viewer may tap an actor on the screen or tap a Pick function in played different variety shows to select the performance of a favorite actor. The selected actor floats in the operation management area. The viewer may select a plurality of actors in a plurality of programs.

Manner 2: The client presents, in the operation management area in response to an object recognition operation triggered based on the video interface, at least one recognition object recognized based on specified video content, the specified video content being also referred to as second video content and including video content that is in a content library associated with the video interface and meets an automatic recognition rule.

Manner 2 represents that when browsing the video interface, the viewer may trigger the object recognition operation for one or more pieces of to-be-played video content based on the video interface, and display a corresponding recognition result in the operation management area.

A specific triggering manner includes, but is not limited to: control triggering, gesture triggering, specified triggering, and preset action triggering.

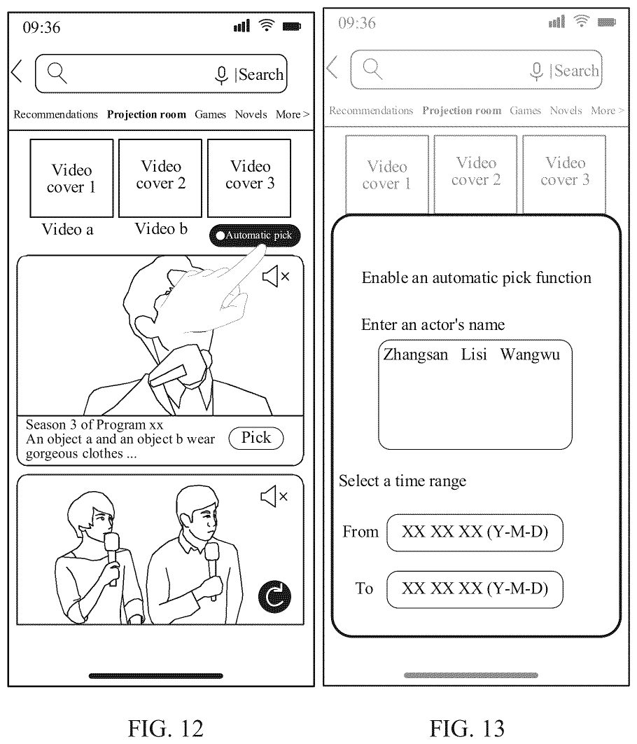

Control triggering is used as an example. An “automatic recognition control”, for example, an “Automatic pick” button in FIG. 12, may be set in the video interface. After tapping the button, the viewer may perform a recognition based on a default automatic recognition rule in a system, for example, filter video content and perform a recognition according to likings of the viewer, or for another example, perform a recognition from video content in at least one setting of a collection, adding a favorite or adding a show to follow, or the like. In addition, the viewer sets the automatic recognition rule. This is not specifically limited herein.

FIG. 12 is a schematic diagram of an automatic pick manner according to an exemplary embodiment of this disclosure. For example, the viewer may tap the “Automatic pick” button in FIG. 12 to enable the automatic pick function. After the automatic recognition rule is set, an actor and content that the viewer likes may be automatically selected according to the rule set by the viewer.

In some exemplary embodiments, after the viewer taps “Automatic pick” and triggers the object recognition operation based on the video interface, the client presents a rule setting interface in response to the operation. The rule setting interface may be a page independent of the video interface, or may be a floating layer, a pop-up window, or another sub-interface of the video interface. This is not specifically limited herein. The viewer may set a corresponding automatic recognition rule based on the interface. Further, the client acquires, in response to an input operation on the rule setting interface, the automatic recognition rule inputted through the rule setting interface.

The set automatic recognition rule includes, but is not limited to: an actor's name, a performance type, a program name, and a time range (for example, a time at which a variety show is aired, a time at which a video is posted).

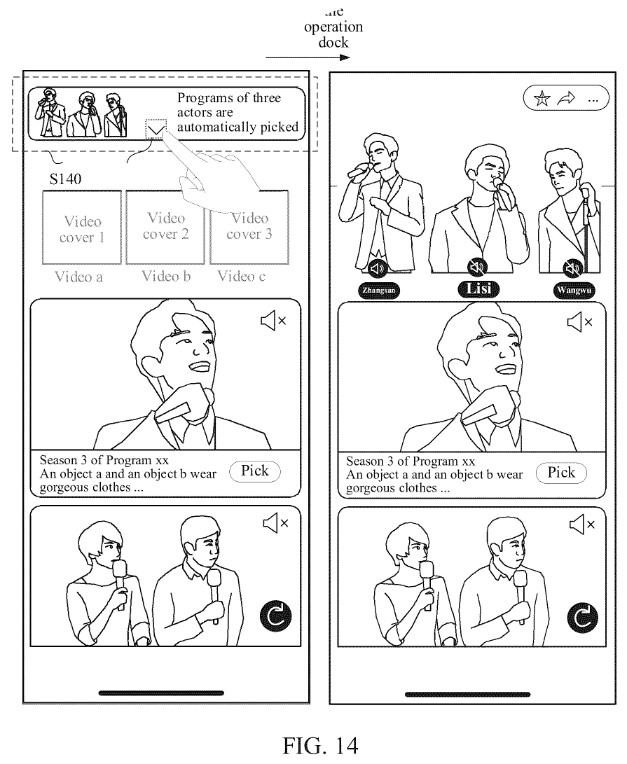

FIG. 13 is a schematic diagram of a setting manner of an automatic recognition rule according to an exemplary embodiment of this disclosure. For example, after the viewer taps the “Automatic pick” button shown in FIG. 12, the rule setting interface may be presented in the video interface in the form of a pop-up window. As shown in FIG. 13, the automatic pick function is enabled. The viewer may enter names of actors that the viewer likes: Zhangsan, Lisi, Wangwu, and may further select a time range.

After acquiring the automatic recognition rule, the client may upload the rule to the server, and the server recognizes specified video content meeting the automatic recognition rule based on the rule and feeds back a recognition result. Further alternatively, after acquiring the automatic recognition rule, the client may automatically recognize specified video content matching the automatic recognition rule and acquire a recognition result.

In the foregoing implementation, the viewer may use an intelligent manner to allow the system to automatically select an actor that the viewer is interested in and place the actor in the operation management area for ease of subsequent related operations. The operations are simple and convenient. In addition, through the automatic recognition manner, a plurality of pieces of video content may be simultaneously recognized to capture a plurality of video clips, and a plurality of repeated operations are not required, so that while the operation complexity is reduced, the loss of the terminal device is reduced.

After some content is automatically selected, a prompt of a selection result is presented. The viewer may expand the prompt to view an actor in the operation management area, and may perform related operations on one or more actors. Some examples are as follows:

In a case of triggering the object recognition operation based on the video interface, before at least one recognition object recognized based on the specified video content is displayed in the operation management area, prompt information of a recognition result for the object recognition operation may be first presented in the video interface through an incompletely expanded operation management area. Further, the viewer triggers an expansion operation, and the client expands the operation management area in response to the expansion operation for the operation management area, and presents, in the expanded operation management area, at least one recognition object recognized based on the specified video content.

FIG. 14 is a schematic diagram of an expansion process of an operation management area according to an exemplary embodiment of this disclosure. A part of a dashed line box S140 in an interface on the left side in FIG. 14 is an example of an incompletely expanded operation management area of this disclosure. Three automatically selected actors (which may be thumbnails or images with reduced sizes) are displayed, and it is prompted with a text “Programs of three actors are automatically picked”. The viewer may tap an identifier shown in S1401 to trigger the expansion operation, to further expand the operation management area to present an interface shown on the right side of FIG. 14 to display (normally display) the recognized three actors.

The foregoing expansion process of the operation management area is only an example for description. Any styles of expanded and incompletely expanded operation management areas are applicable to the exemplary embodiments of this disclosure. Details are not described herein again.

In the foregoing implementation, the prompt manner allows the viewer to quickly learn the recognition result, and the recognition result is presented through the expanded operation management area. In this quick selection manner, a requirement of watching the performance of all favorite actors at once of the viewer can be met, and the experience of picking clips, watching clips later, and the like can be completed with one tap.

S23: The client plays at least one video clip in the operation management area according to a set of playback rules a set of playback rules.

The playback rule in Operation S23 may be set by the viewer or may be set by default in the system. If it is set by default in the system that each time one recognition object is displayed in the operation management area, video clips of the recognition object can be played automatically, when a new video clip is played each time, the playback of a previous video clip may be paused or muted, or it is set by default in the system to play all video clips in order. This is not specifically limited herein.

In this disclosure, an actor selected by the viewer carries information of an original program, and includes, but is not limited to, a fixed clip or an intelligently recognized clip of a complete program. The viewer may perform related operations such as playback and pause on the actor in the operation management area. In addition, for all the recognition objects, content of performance is played according to a specific rule.

In some exemplary embodiments, the playback rule may be set in the following manner:

The viewer may trigger a playback setting operation through a related setting control in the operation management area or a speech instruction, and the client presents at least one playback setting option in response to the playback setting operation triggered based on the operation management area. The viewer selects one of the playback setting options, and the client plays, in the operation management area in response to a selection operation on a target option in the at least one playback setting option based on a playback rule corresponding to the target option, a video clip matching the playback rule.

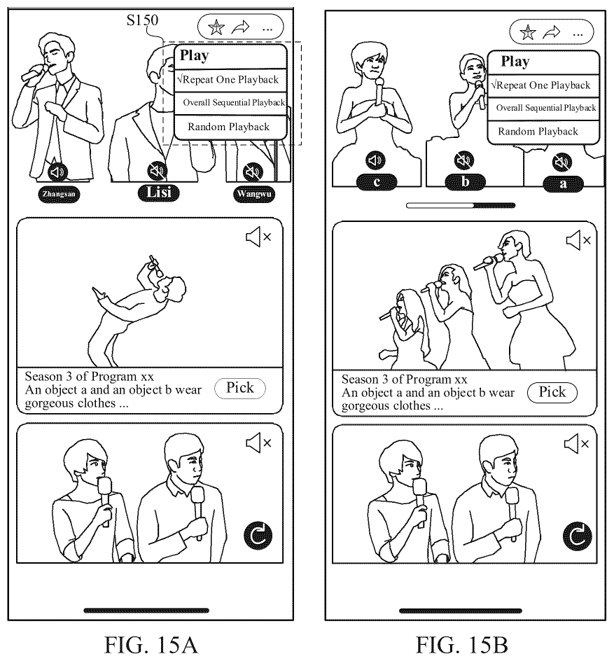

FIG. 15A is a schematic diagram of a playback setting manner according to an exemplary embodiment of this disclosure. The operation management area listed in FIG. 9B is used as an example in FIG. 15A. The viewer taps “ . . . ” at the upper right corner to present several playback setting options, for example, “Repeat One Playback”, “Overall Sequential Playback”, and “Random Playback”, shown in a dashed line box S150.

“Repeat One Playback” is playing a program of a single actor repeatedly, and through the option, it is set to repeatedly play a video clip of a single actor. “Overall Sequential Playback” is sequentially playing video clips of actors in the operation management area according to a specific order. “Random Playback” is randomly playing video clips of one or several actors in the operation management area according to a random order.

FIG. 15B is a schematic diagram of another playback setting manner according to an exemplary embodiment of this disclosure. The operation management area listed in FIG. 11F is used as an example in FIG. 15B. Similarly, the viewer taps “ . . . ” at the upper right corner to present several playback setting options, for example, “Repeat One Playback”, “Overall Sequential Playback”, and “Random Playback”, listed in FIG. 15B.

For example, the viewer selects “Repeat One Playback”, and sets repeated playback of video clips of “a”. In other words, repeated playback of program clips corresponding to “a” is turned on in the operation management area. For another example, the viewer selects “Repeat One Playback”, and sets repeated playback of video clips of one or more recognition objects. In other words, according to a default rule, for example, according to an arrangement order, repeated playback of program clips corresponding to “c” that is arranged at the top is turned on in the operation management area. This is not specifically limited herein.

The recorded playback setting option listed above is only a simple example for description. Another playback setting option may be set by a developer according to a user requirement, or a user may customize a playback setting option/rule. For example, the viewer sets how to play one or more video clips. This is not specifically limited herein.

In the foregoing implementation, through fast playback, quick operations, and other technologies in the operation management area, when browsing subsequent content, the viewer may simultaneously watch the performance of a favorite object (for example, an actor). The performance of a single object or a plurality of objects may be played according to different rules, thereby greatly improving the experience of browsing subsequent content and watching the performance of an object simultaneously, and increasing a watching duration of the viewer.

Related operations of the operation management area are described below.

In this disclosure, the operation management area may carry many recognition objects, and the viewer may perform related operations of a single recognition object or a plurality of recognition objects.

In some exemplary embodiments, the client performs, in response to a first specified operation triggered for at least one specified recognition object in the operation management area, a corresponding processing logic on a video clip corresponding to the at least one recognition object based on the first specified operation.

The first specified operation includes at least one of a playback control operation and a content processing operation on a video clip.

The playback control operation in this disclosure includes an operation of controlling a playback state of a video clip, for example, playing the video clip, or pausing the video clip, or an operation of controlling volume of the video clip, for example, a muting operation, or a volume adjustment operation. The content processing operation includes some processing such as sharing, downloading, deleting, collecting, and returning to a program performed on content of the video clip.

The returning to a problem means returning to an original program, i.e., returning to video content to which the video clip belongs for playback.

In this disclosure, the first specified operation may be performed on a single recognition object in the operation management area, for example, sharing a video clip of “Zhangsan”, or playing a video clip of “Lisi”. Alternatively, the first specified operation may be synchronously performed on some recognition objects in batches, for example, collecting video clips of a plurality of actors in batches.

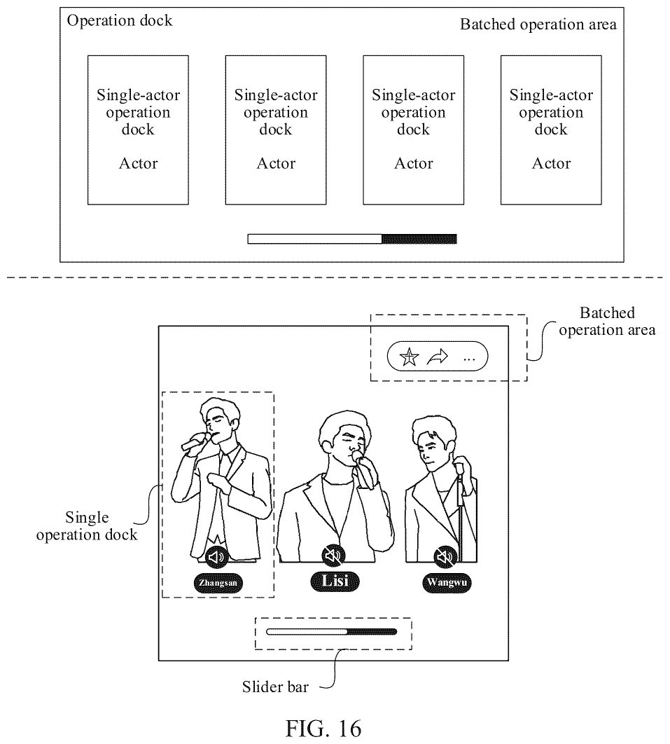

FIG. 16 is a schematic diagram of a layout style of an operation dock according to an exemplary embodiment of this disclosure. A setting style of operation docks is listed above a dash line in FIG. 16, and a specific example of operation docks is provided below the corresponding dash line. In the setting style shown in FIG. 16, for the operation docks, operation docks of single actors (i.e., recognition objects) are displayed in a horizontal arrangement, and operation docks of three single actors are listed corresponding to examples below and respectively correspond to Zhangsan, Lisi, and Wangwu, and names of the actors are displayed below. In addition, a batched operation area may be set at the upper right corner of the operation docks, including, for example, collecting, sharing, and other operations (for example, playback settings) listed in this disclosure. Further, a slider bar is further displayed below the operation docks of the single actors. Through the slider bar, a swipe may be performed in the operation docks to view the actors and corresponding video clips.

The layout style of the operation docks listed in FIG. 16 is only a simple example, and another layout style may be used. This is not specifically limited herein.

The viewer may perform a single operation on a corresponding actor through an operation dock of a single actor in the operation docks; or may perform related batched operations such as setting a playback order, collecting, downloading, sharing, and deleting on a plurality of actors through the batched operation area.

The specified recognition object in this disclosure includes any one or more recognition objects in the operation management area, and is specified by the viewer according to an operation requirement. Correspondingly, the specified collected recognition object is any one or more recognition objects in a collection interface, or may be specified by the viewer according to an operation requirement. This is not specifically limited.

In some exemplary embodiments, the viewer may trigger a specified operation based on the following manner:

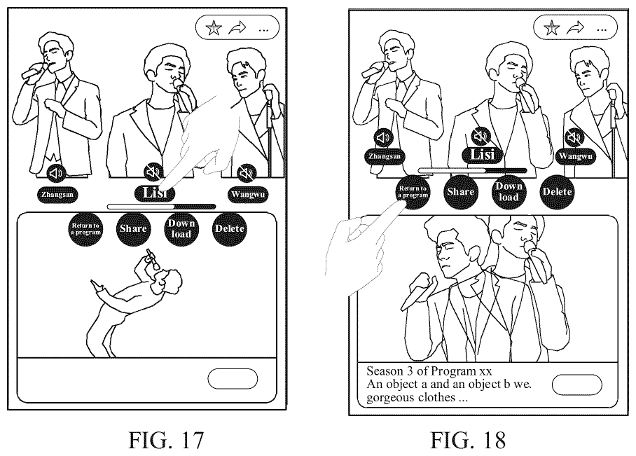

The viewer may perform a management operation on one or more specified recognition objects in the operation management area. Further, the client presents, in response to the management operations triggered by the viewer for the specified recognition objects in the operation management area, at least one first operation control on each of the specified recognition objects. FIG. 17 is a schematic diagram of an operation control according to an exemplary embodiment of this disclosure. The viewer may tap a recognition object, for example, tap “Lisi”, and operation controls (which may be denoted as first operation controls) including “Return to a program”, “Share”, “Download”, and “Delete” shown in FIG. 17 are presented.

Further, the viewer may select any operation control from the at least one first operation control. The client performs, in response to a first specified operation triggered by the viewer based on a target operation control and based on the first specified operation, the corresponding processing logic on a video clip corresponding to a recognition object corresponding to the first operation control.

For example, the viewer selects “Share”, the video clip of “Lisi” is shared according to the operation of the viewer. For another example, the viewer selects “Dowwload”, the video clip of “Lisi” is downloaded according to the operation of the viewer, and the video clip may be further saved. For another example, the viewer selects “Delete”, “Lisi” and the corresponding video clip are deleted from the operation management area.

In addition, operations such as playback, pausing, and muting listed above may be triggered in the form of the operation control listed in FIG. 17. This is not specifically limited herein.

An execution manner of the program return operation is described below in detail.

If the first specified operation is a program return operation in the content processing operation, a process of performing the corresponding processing logic on a video clip corresponding to one specified recognition object based on the program return operation is as follows:
jumping from the operation management area to the video interface based on the program return operation, and continuing to play video content to which the video clip corresponding to the recognition object corresponding to the first operation control belongs in the video interface.

FIG. 18 is a schematic diagram of a program return operation according to an exemplary embodiment of this disclosure. The operation management area floats at the top of the video interface. When the viewer triggers the “Return to a program” control for “Lisi” in the operation management area to perform an operation of returning to a program, the operation management area may be collapsed, and a jump is made to a related position of the video clip corresponding to “Lisi” in the video interface to continue with playback. Alternatively, the operation management area remains unchanged, and a jump is directly made to a related position of the video clip corresponding to “Lisi” in the video interface to continue with playback, as shown in FIG. 18.

The related position may be a position of a starting time point of the video clip corresponding to “Lisi” in the video content to which the video clip belongs. Alternatively, if the video clip of “Lisi” is currently played in the operation management area, the related position may be a position of a current playback time point of the video clip in the video content to which the video clip belongs. This is not specifically limited herein.

In the foregoing implementation, the viewer may perform a separate operation (deleting, downloading, sharing, returning to a program, or the like) on an actor in the operation management area, or may perform a batched operation (overall sequential playback, repeated playback, sharing, or the like) on all selected actors. Based on this, more quick operations such as collecting, downloading, and returning to an original program are provided, so that the viewer can complete quick operations in a What You See Is What You Get manner.

In the exemplary embodiments of this disclosure, the viewer may collect one or more recognition objects and corresponding video clips. For example, the viewer may place all selected actors in a collection list with one tap, and perform a corresponding operation in the collection list.

In some exemplary embodiments, the client presents the collection interface in response to a collection viewing operation triggered based on the operation management area, the collection interface displaying at least one collected recognition object and a corresponding video clip.

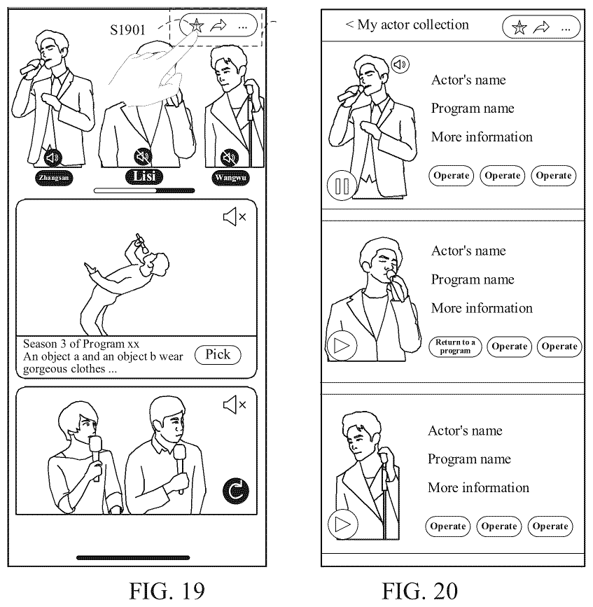

FIG. 19 is a schematic diagram of a collection process according to an exemplary embodiment of this disclosure. The viewer may further tap a control S1901 (i.e., a collection button) shown in S190 to trigger a collection viewing operation, to present the collection interface (i.e., the collection list) shown in FIG. 20.

FIG. 20 is a schematic diagram of a collection interface according to an exemplary embodiment of this disclosure. In the collection interface, collected recognition objects and corresponding video clips are displayed.

In addition, in the collection interface, one or more video clips may be directly played. For example, in FIG. 20, a video clip of “Zhangsan” is played, and video clips of “Lisi” and “Wangwu” are not played. In addition, an actor's name, a program name, and more information may be further displayed.

In this disclosure, to distinguish the specified operation triggered for the collection interface from the specified operation triggered based on the operation management area, the specified operation triggered based on the operation management area is used as the first specified operation, and the specified operation triggered for the collection interface is used as a second specified operation.

Similar to the first specified operation listed above, the viewer may trigger the second specified operation on the specified collected recognition object, and some exemplary embodiments are:
performing, in response to a second specified operation triggered for any collected recognition object in the at least one collected recognition object in the collection interface, a corresponding processing logic on a video clip corresponding to the collected recognition object.

The second specified operation includes at least one of a playback control operation and a content processing operation on a video clip. The second specified operation discussed here is similar to the first specified operation, and may also be at least one of a playback control operation and a content processing operation.

The playback control operation includes, but is not limited to, playback, pausing, muting, and adjusting volume. The content processing operation includes, but is not limited to, sharing, downloading, deleting, and returning to a program. Different from the first specified operation, the second specified operation is discussed for a collected recognition object. The corresponding content processing operation does not include “Collect”. Correspondingly, the deletion operation represents deleting one or more collected recognition objects and corresponding video clips from the collection list, that is, canceling collection.

In some exemplary embodiments, the collection interface further includes second operation controls, for example, “Operate” and “Return to a program” shown in FIG. 20, related to collected recognition objects. The “Operate” button listed in FIG. 20 may be any second specified operation. This is not specifically limited herein.

If the second specified operation is a program return operation, in the collection interface, when the viewer triggers the program return operation based on the second operation control related to any collected recognition object, the client jumps from the collection interface to the video interface in response to the program return operation, and continues to play video content to which the video clip corresponding to the collected recognition object belongs in the video interface.

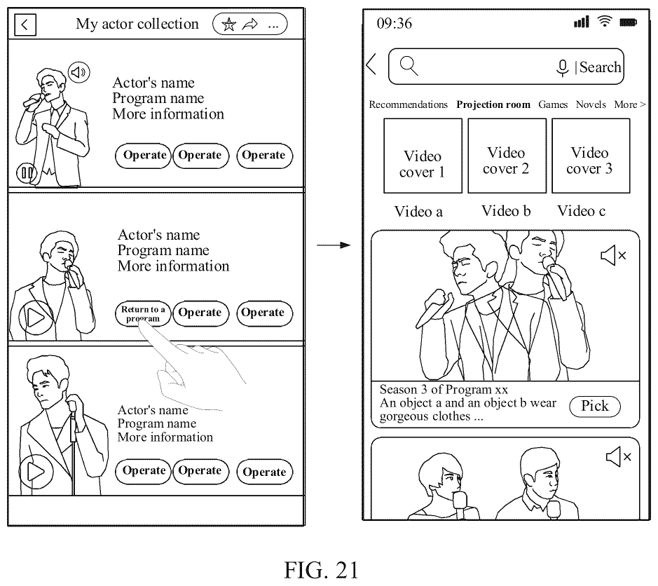

This is similar to the program return operation listed in the part of the first specified operation, and a difference lies in that in this manner, the client jumps from the collection interface to the video interface. FIG. 21 is a schematic diagram of another program return operation according to an exemplary embodiment of this disclosure. After the viewer triggers the program return operation for “Lisi” in the collection interface, the client may directly jump to the related position of the video clip corresponding to “Lisi” in the video interface to continue with playback.

The related position may be a position of a starting time point of the video clip corresponding to “Lisi” in the video content to which the video clip belongs. Alternatively, if the video clip of “Lisi” is currently played in the collection interface, the related position may be a position of a current playback time point of the video clip in the video content to which the video clip belongs. This is not specifically limited herein.

In the foregoing implementation, the viewer may perform batched operations such as collection on all recognition objects. After collection, all selected recognition objects may be placed in the collection list with one tap, and corresponding operations are performed in the collection list, so that operations are convenient. In addition, “Return to a program” may be tapped in the collection interface, so that the viewer can quickly locate content of the original program, thereby implementing the navigation of quickly locating original content.

In this disclosure, the operation management area may carry many recognition objects. A horizontal arrangement of recognition objects in the operation management area is used as an example. As a quantity of recognition objects increases, previously selected recognition objects are gradually moved to the left. Restricted by screen display, a current interface may fail to completely display all recognition objects. Based on this, the viewer may perform a swipe to view all recognition objects, and in some exemplary embodiments,
in response to a swipe operation triggered based on the operation management area, the client swipes and views recognition objects and corresponding video clips in the operation management area.

In other words, the viewer in this disclosure may select a plurality of actors in one picture to enter the operation management area, and all the actors can be swiped and viewed, and related operations on a single or a plurality of actors may be performed.

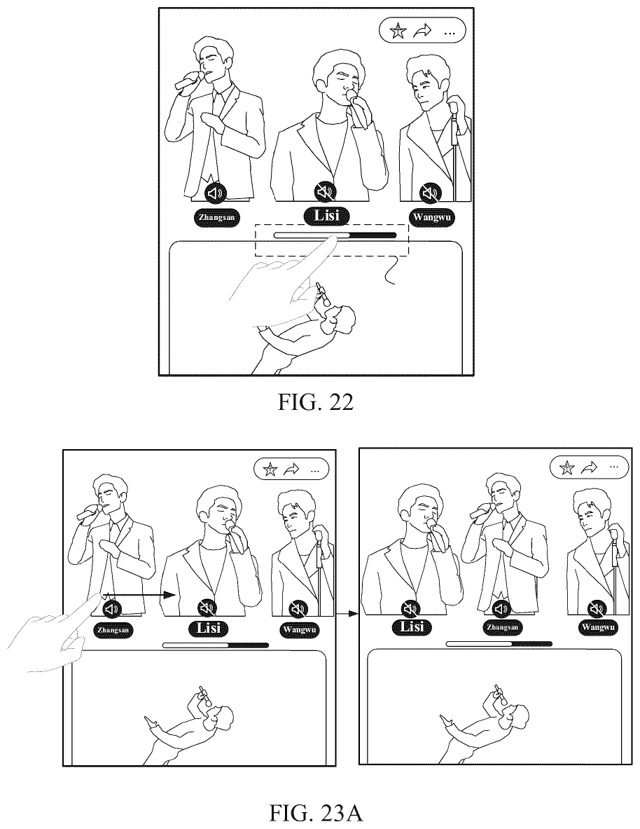

FIG. 22 is a schematic diagram of a swipe process according to an exemplary embodiment of this disclosure. Restricted by a screen size, a current operation management area only presents three recognition objects, namely, Zhangsan, Lisi, and Wangwu. The viewer may tap a slider bar shown in S220 to view other recognition objects that are not displayed on a current screen. The slider bar is partially white and partially black, and different colors may be used to distinguish a ratio of currently viewed recognition objects to unviewed recognition objects.

In this disclosure, an arrangement form of the recognition objects in the operation management area includes, but is not limited to, a horizontal form, a vertical manner, or the like. The viewer may adjust a position order of the recognition objects in a drag manner or the like. Some examples are as follows:

In response to a position adjustment operation on at least one specified recognition object in the operation management area, the client updates an arrangement order of these specified recognition objects in the operation management area.

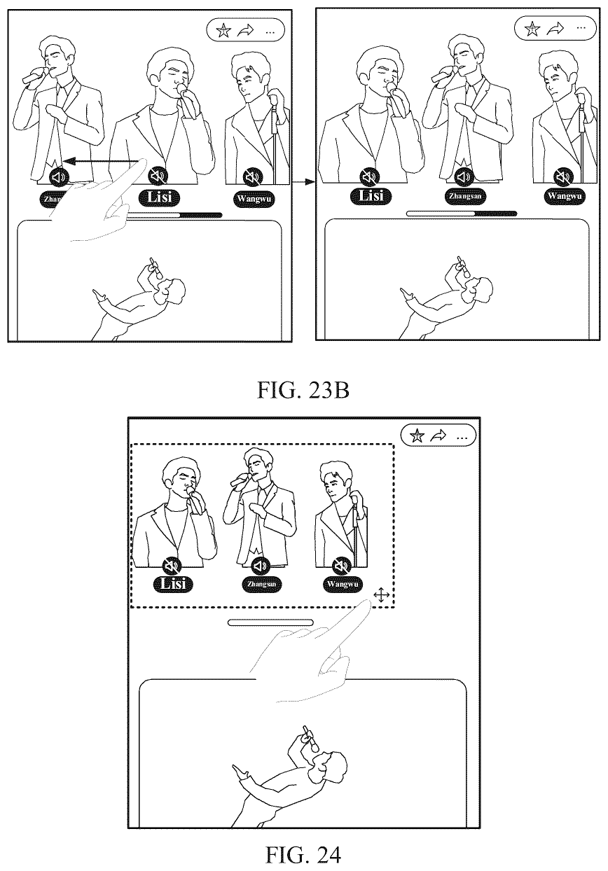

FIG. 23A is a schematic diagram of an object position adjustment according to an exemplary embodiment of this disclosure. For example, when positions of “Zhangsan” and “Lisi” are to be switched, “Lisi” may be dragged to the left side of “Zhangsan”. FIG. 23B is a schematic diagram of another object position adjustment according to an exemplary embodiment of this disclosure. When the positions of “Zhangsan” and “Lisi” are to be switched, “Zhangsan” may be dragged to the right side of “Lisi”.

In this disclosure, the viewer may further increase, reduce, or perform another operation on display sizes of recognition objects in the operation management area, and some exemplary embodiments are:

In response to a size adjustment operation on at least one specified recognition object in the operation management area, the client updates display sizes of these specified recognition objects and a corresponding video clip in the operation management area.

For the adjustment of the size of the recognition object, sizes of all recognition objects in the operation management area may be generally increased or reduced, or the size of a recognition object may be separately increased or reduced.

FIG. 24 is a schematic diagram of a display size adjustment according to an exemplary embodiment of this disclosure. FIG. 24 represents reducing overall sizes of all recognition objects in an operation management area.

In the foregoing exemplary embodiments, a viewer may swipe and view all recognition objects in an operation management area. The viewer may browse and view content of all operation docks and adjust display sizes of the recognition objects, and may further drag and adjust a position order of the recognition objects. These operations may all be directly completed in the operation management area, so that an operation path is short, and batched operations may be performed on a plurality of recognition objects, so that device resources and network resources consumed to frequently repeat an action are avoided, and the efficiency of human-computer interaction is also improved.

The video playback method in the exemplary embodiments of this disclosure is mainly described above from a client side. The video playback method in the exemplary embodiments of this disclosure is further described below in conjunction with a server.

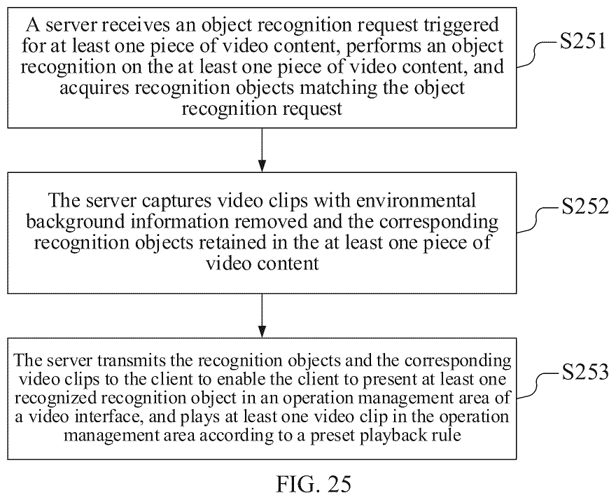

FIG. 25 is a schematic diagram of another implementation of a video playback method according to an exemplary embodiment of this disclosure. An example in which a server is an execution entity is used. A specific implementation procedure of the method is S251 to S253 as follows:

S251: The server receives an object recognition request triggered for at least one piece of video content, performs an object recognition on the at least one piece of video content, and acquires recognition objects matching the object recognition request.

The object recognition request is transmitted by a client in response to an object recognition operation triggered for the at least one piece of video content. Corresponding to the foregoing several manners on the client side, the server may recognize a current playback picture (including one or more objects) of a target video content currently played on a video interface, or recognize video content meeting an automatic recognition rule from a content library associated with the video interface. Details are not described herein again.

FIG. 5A is used as an example. When a viewer long presses a position of an actor on a screen, an object recognition operation may be triggered. In response to the object recognition operation, a client transmits a corresponding object recognition request to the server. After receiving the request, the server recognizes the current playback picture of the target video content.

FIG. 5B is used as an example. When a viewer taps a “Pick” button, an object recognition operation may be triggered. In response to the object recognition operation, a client transmits a corresponding object recognition request to the server. After receiving the request, the server recognizes the current playback picture of the target video content.

Further, FIG. 12 and FIG. 13 are used as an example. A viewer taps an “Automatic pick” button and sets a corresponding automatic recognition rule, an object recognition operation may be triggered. In response to the object recognition operation, a client transmits a corresponding object recognition request (which may carry the set automatic recognition rule) to the server. After receiving the request, the server recognizes video content meeting the automatic recognition rule in a content library associated with the video interface.

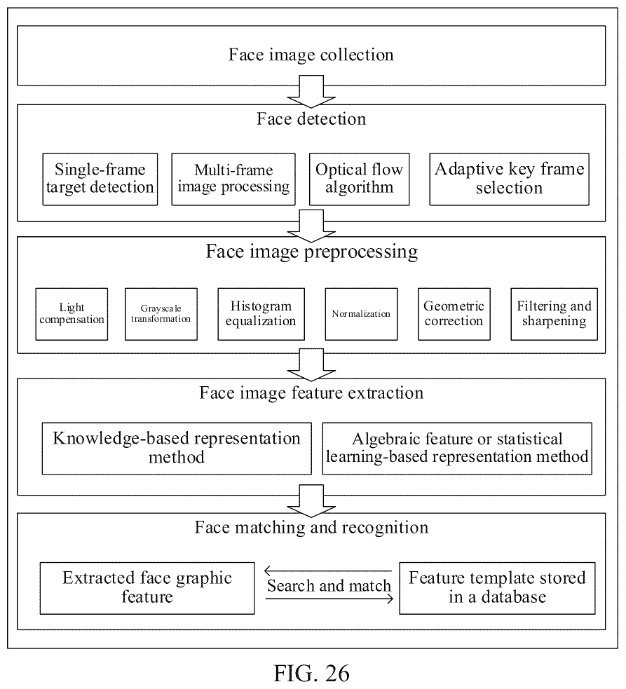

An example in which a recognition object is an actor is used. A related technical process of picking an actor by the server may be understood as a face recognition process of an actor. FIG. 26 is a schematic diagram of a face recognition procedure according to an exemplary embodiment of this disclosure. The face recognition specifically includes face image collection, face detection, face image preprocessing, face image feature extraction, and face matching and recognition. The parts are briefly described below.

(1) Face image collection: Through an operation of the viewer, an information collection is performed on an image including a face in a video picture.

As shown in FIG. 5A and FIG. 5B, a current playback picture includes one face, and an information collection may be performed on an image including a face in the picture.

(2) Face detection: Information meeting a face feature is usually detected based on features by using an Adaboost learning algorithm (an iteration algorithm). In this disclosure, during the face detection of video content, corresponding video target detection algorithms include, but not limited to, single-frame target detection, multi-frame image processing, an optical flow algorithm, and adaptive key frame selection. This is not specifically limited herein.

(3) Face image preprocessing: An image is preprocessed based on a result of the face detection. A processing process mainly includes one or more of light compensation, grayscale transformation, histogram equalization, normalization, geometric correction, filtering and sharpening, and the like.

(4) Face image feature extraction: Extraction methods generally include a knowledge-based representation method and an algebraic feature or statistical learning-based representation method. This is not specifically limited herein.

(5) Face matching and recognition: A search and a matching are performed on an extracted feature of a face graphic and a feature template stored in a database. For example, a matching is performed by setting a similarity threshold (for example, a matching succeeds if a similarity exceeds 95%), and a result is outputted if the threshold is met.

Based on the foregoing implementation, a recognition object that appears in video content can be effectively detected, and a recognition object meeting a requirement of the viewer is selected.

In some exemplary embodiments, after Operation S251 and before Operation S252, confirmation information for recognized recognition objects may be further transmitted to the client to enable the client to display identifier information of the recognition objects in an operation management area.

The confirmation information for the recognition objects fed back by the server corresponds to the identifier information displayed on the client side. The confirmation information includes, but is not limited to, a position of a recognized object in a video picture, a name and a gender of the object, and a program name.

In the foregoing implementation, the server feeds back secondary confirmation information of the recognized object to the client, so that the viewer may be prompted to check whether the recognized object is an object that the viewer wants to view. Based on this, the viewer may further confirm a recognition object to select the recognition object, and display the recognition object in the operation management area, thereby ensuring the accuracy of the recognition result.

S252: The server captures video clips with environmental background information removed and the corresponding recognition objects retained in the at least one piece of video content.

Each recognition object corresponds to one video clip. For details, refer to the foregoing exemplary embodiments. Details are not described herein again.

If the server feeds back the confirmation information for the recognition objects to the client before Operation S252, some exemplary embodiments of Operation S252 are as follows:
each time a confirmation request returned by the client for one recognition object is received, capturing video clips with the environmental background information removed and the recognition object retained in the corresponding video content, the confirmation request being transmitted by the client in response to a confirmation operation on the recognition object.

In other words, in a case that the viewer needs to perform a secondary confirmation, when the viewer confirms the selection of a recognition object based on identifier information displayed by the client, the server needs to further capture video clips of the recognition object.

As shown in FIG. 8A, after the viewer taps “OK”, the client may transmit a confirmation request for Zhangsan to the server, and the server captures, from corresponding video content (i.e., Season 3 of Program xx, Object a and Object b . . . ), video clips with environmental background information removed and only information such as an image, a video, and audio of Zhangsan retrained.

Further, as shown in FIG. 11C, after the viewer taps “OK”, the client may transmit a confirmation request for “c” to the server, and the server captures, from corresponding video content (i.e., Season 3 of Program xx, Object a and Object b . . . ), video clips with environmental background information removed and only information such as an image, a video, and audio of “c” retrained.

In the foregoing implementation, the viewer may tap an actor on the screen or tap a pick function in played different variety shows to select the performance of a favorite actor. In this manner of quickly selecting a program of an actor, a requirement of watching the performance of all favorite actors at once by the viewer can be met, and the experience of selecting clips and watching clips later can be completed with one tap.

S253: The server transmits the recognition objects and the corresponding video clips to the client to enable the client to present at least one recognized recognition object in an operation management area of a video interface, and plays at least one video clip in the operation management area according to a preset playback rule.

The video interface is configured for displaying at least one piece of video content.

In the foregoing implementation, through the interaction between the server and the client, fast playback, quick operations, and other technologies in the operation management area can be implemented, and when browsing subsequent content, the viewer may simultaneously watch the performance of a favorite object (for example, an actor). The performance of a single object or a plurality of objects may be played according to different rules, thereby greatly improving the experience of browsing subsequent content and watching the performance of an object simultaneously, and increasing a watching duration of the viewer.

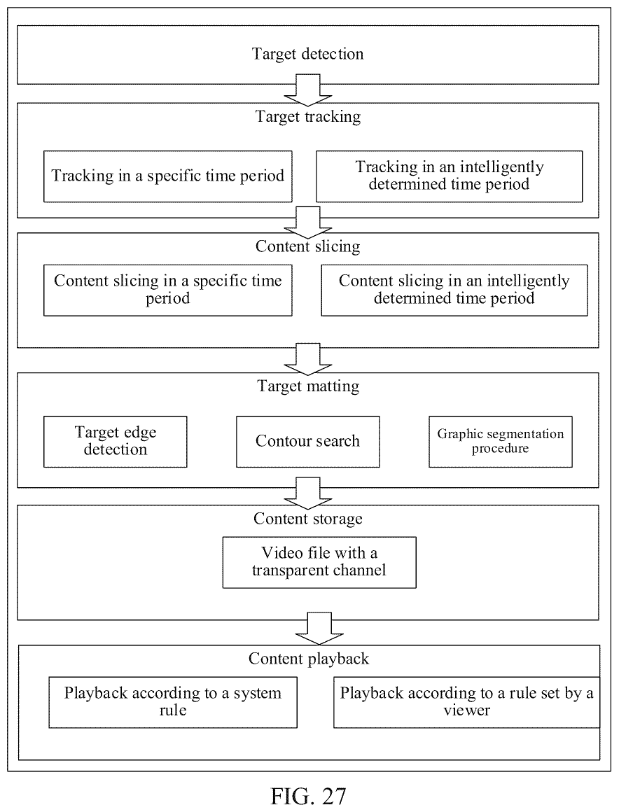

An actor is still used as an example below to describe a processing and playback procedure of video content of an actor in this disclosure. FIG. 27 is a schematic diagram of a procedure of processing and playing video content according to an exemplary embodiment of this disclosure. The procedure includes target detection, target tracking, content slicing, target matting, content storage, and content playback. These parts are briefly described below.

(1) Target detection: The target detection listed corresponds to the face recognition part in FIG. 26. Through the process of the face recognition and the secondary confirmation of the viewer, a detection object may be determined.

(2) Target tracking: Target tracking includes tracking of an object in a specific time period and tracking of an object in an intelligently determined time period. The tracking in a specific time period means determining a specific performance time period (for example, 5 seconds or 10 seconds) of a target object through target tracking. The tracking in an intelligently determined time period means intelligently determining a complete performance time period through the continuity of a target action, video content, music content, and the like.

The target object is a recognized recognition object herein, or a recognition object confirmed by the viewer.

(3) Content slicing: Video content in a time period of target performance is sliced. The content slicing corresponds to two manners during target tracking, and includes content slicing in a specific time period and content slicing in an intelligently determined time period.

(4) Target matting: A target in a video slice is matted through target edge detection, contour search, and a graphic segmentation procedure, a person is extracted, and a background image is removed, to form a video of an actor with a transparent channel.

In other words, the video is a video clip corresponding to a recognition object herein. The video clip is a video with environmental background information removed and with a transparent bottom.

(5) Content storage: The video clip with a transparent channel is stored in the server and stored as a video file with a transparent channel.

(6) Content playback: The server delivers the video content with an actor to an operation management area of the client for displaying and playback, and a plurality of playback forms may be used according to a system rule or a rule set by the viewer.

For a specific playback form, refer to the foregoing exemplary embodiments. Details are not described herein again.

In some exemplary embodiments, in an automatic recognition manner in this disclosure, the automatic recognition rule may be set by the viewer. In this case, the client may add the automatic recognition rule set by the viewer to the object recognition request (or the automatic recognition rule and the object recognition request may be separately transmitted) and upload the object recognition request to the server. In a case that the server detects the automatic recognition rule uploaded by the client, video content meeting the automatic recognition rule may be selected from the content library associated with the video interface based on the automatic recognition rule. Further, an object recognition is performed on the selected video content to acquire a recognition object matching the automatic recognition rule.

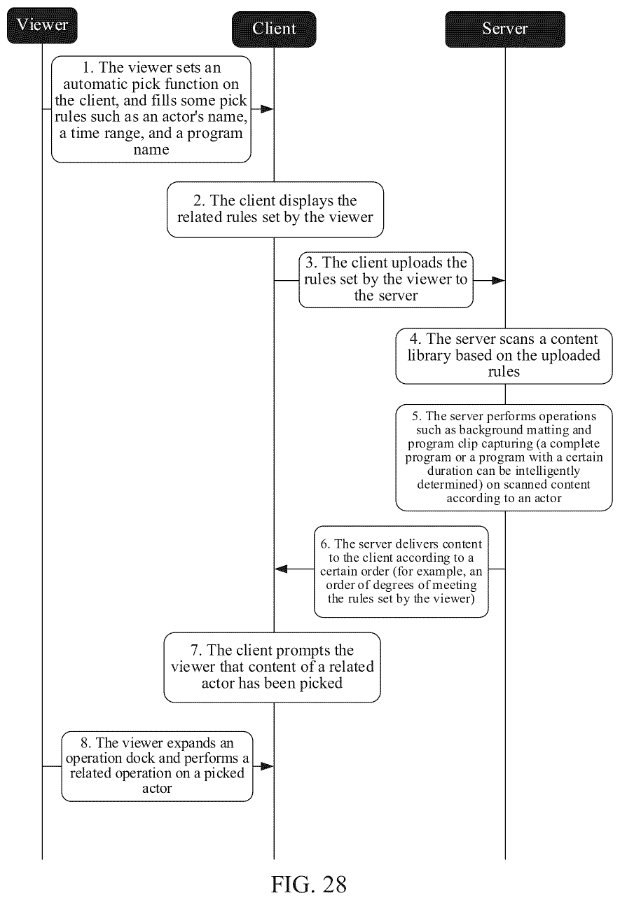

FIG. 28 is a schematic diagram of an interaction process of automatically recognizing an actor according to an exemplary embodiment of this disclosure, specifically including the following operations:

1. The viewer sets an automatic pick function on the client (for example, a long video platform), and fills some pick rules such as an actor's name, a time range, and a program name.

2. The client displays the related rules set by the viewer.

3. The client uploads the rules set by the viewer to the server (for example, adds the rules set by the viewer to the object recognition request for transmission).

4. The server scans a content library based on the uploaded rules.

5. The server performs operations such as background matting and program clip capturing (a complete program or a program with a certain duration can be intelligently determined) on scanned content according to an actor.

6. The server delivers content to the client according to a certain order (for example, an order of degrees of meeting the rules set by the viewer).

In some exemplary embodiments, when transmitting the video clips corresponding to the recognition objects to the client, the server may transmit the recognition objects and the corresponding video clips to the client according to a specified order. The specified order may be customized by the server or set by default in a system. The specified order is associated with the automatic recognition rule.

For example, it is set in the automatic recognition rule that favorite actors are sequentially Zhangsan, Lisi, and Wangwu. When providing a feedback to the client, the server may preferentially feed back related information of Zhangsan and then information of Lisi and Wangwu according to the foregoing liking degrees, to comply with a requirement of the viewer.

7. The client prompts the viewer that content of a related actor has been picked.

8. The viewer expands an operation dock and performs a related operation (playback, sharing, deletion, or the like) on a picked actor.

In this disclosure, the viewer may swipe and view all actors in the operation dock, and perform a separate operation (deleting, downloading, sharing, returning to a program, or the like) on an actor in the operation management area, or may perform a batched operation (overall playback, repeated playback, sharing, or the like) on all selected actors.

In some exemplary embodiments, after the viewer triggers a program return operation for a specified video clip, the client may transmit a program return request for the specified video clip to the server. After receiving the request, the server may recognize a playback position associated with the specified video clip based on historical request data of the specified video clip. Further, the playback position is fed back to the client, so that the client continues to play video content to which the specified video clip belongs in the video interface based on the playback position.

The historical request data may be a time point at which the viewer triggers an object recognition request for video content corresponding to the specified video clip, a playback time point of the corresponding video content. If the specified video clip is obtained through an automatic recognition, the historical request data may be a time point at which the viewer triggers the automatic recognition, or the like. This is not specifically limited herein.

For example, the viewer triggers an object recognition request for Zhangsan when an xx program is played to 00:02:02, the corresponding playback position may be determined as 00:02:02. To be specific, after the viewer triggers a program return operation for a specified video clip corresponding to Zhangsan, a jump may be made back to 00:02:02 of the program to continue with the playback.

Alternatively, the historical request data may further include a latest position of an object during playback of the specified video clip in the operation management area or a collection interface.

For example, the viewer plays the specified video clip in the operation management area to 00:01:00, the viewer requests a recognition at a moment when an original program is played to 00:02:02, and the specified video clip starts to be captured from the moment of 00:02:02. The time corresponds to 00:03:02 in the original program. The corresponding playback position may be determined as 00:02:02. To be specific, after the viewer triggers a program return operation for a specified video clip corresponding to Zhangsan, a jump may be made back to 00:03:02 of the program to continue with the playback.

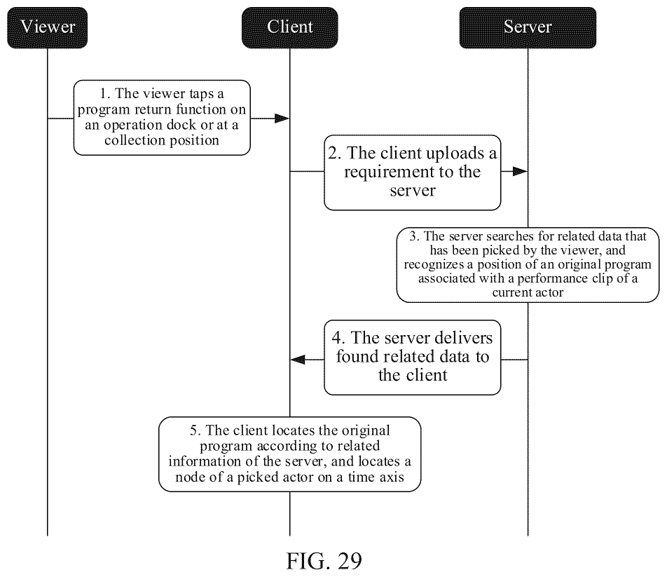

FIG. 29 is a schematic diagram of a procedure of returning to an original program through a selected actor according to an exemplary embodiment of this disclosure, specifically including the following operations:

1. The viewer taps a program return function on an operation dock or at a collection position.

2. The client uploads a requirement to the server.

3. The server searches for related data that has been picked by the viewer, and recognizes a position of an original program associated with a performance clip of a current actor.

4. The server delivers found related data to the client.

5. The client locates the original program according to related information of the server, and locates a node of a picked actor on a time axis.

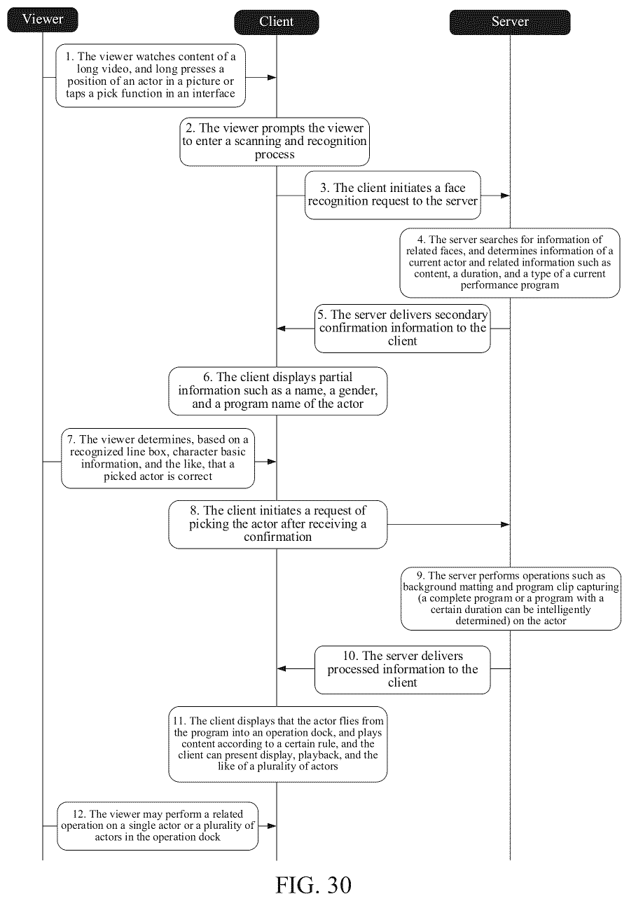

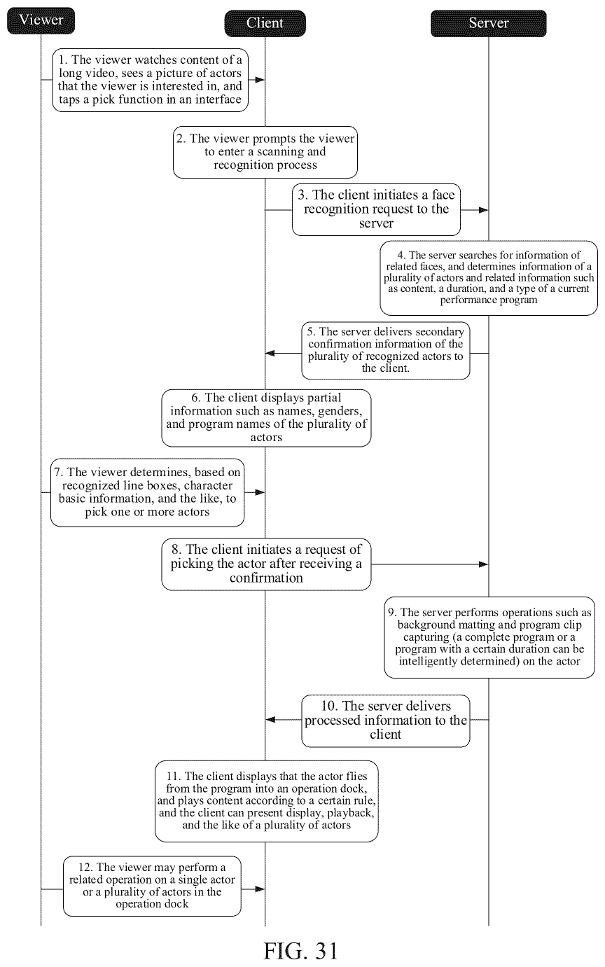

A diagram of an interaction procedure of automatically recognizing an actor is listed in FIG. 28 above. Based on different quantities of actors included in a picture, interaction procedures of manually triggering a recognition are respectively briefly described below based on FIG. 30 and FIG. 31.

An example in which one actor exists in a picture is used below. FIG. 30 is a schematic diagram of an authorization and interaction process of a single actor between a client and a server according to an exemplary embodiment of this disclosure. A specific procedure is as follows:

1. The viewer watches content of a long video, sees a picture of an actor that the viewer is interested in, and long presses a position of an actor in a picture (an appropriate duration is set based on different device or viewer groups, and is, for example, 2 seconds, or 3 seconds) or taps a pick function in an interface.

2. The viewer prompts the viewer to enter a scanning and recognition process.

3. The client initiates a face recognition request (i.e., an object recognition request) to the server.

4. The server searches for information of related faces, and determines information of a current actor and related information such as content, a duration, and a type of a current performance program.

5. The server delivers secondary confirmation information to the client.

6. The client displays partial information such as a name, a gender, and a program name of the actor.

7. The viewer determines, based on a recognized line box, character basic information, and the like, that a picked actor is correct.

8. The client initiates a request of picking the actor after receiving a confirmation.

9. The server performs operations such as background matting and program clip capturing (a complete program or a program with a certain duration can be intelligently determined) on the actor.

10. The server delivers processed information to the client.

11. The client displays that the actor flies from the program into an operation dock, and plays content according to a certain rule, and the client can present display, playback, and the like of a plurality of actors.

12. The viewer may perform a related operation on a single actor or a plurality of actors in the operation dock.

An example in which a plurality of actors exist in a picture is used below. FIG. 31 is a schematic diagram of an authorization and interaction process of a plurality of actors between a client and a server according to an exemplary embodiment of this disclosure. A specific procedure is as follows:

1. The viewer watches content of a long video, sees a picture of actors that the viewer is interested in, and taps a pick function in an interface.

In a picture with a plurality of actors, a single actor may be separately selected through a long press on the screen. A technical process of the selection remains consistent with the foregoing process of selecting a picture of a single actor.

2. The viewer prompts the viewer to enter a scanning and recognition process.

3. The client initiates a face recognition request to the server.

4. The server searches for information of related faces, and determines information of a plurality of actors and related information such as content, a duration, and a type of a current performance program.

5. The server delivers secondary confirmation information of the plurality of recognized actors to the client.

6. The client displays partial information such as names, genders, and program names of the plurality of actors.

7. The viewer determines, based on recognized line boxes, character basic information, and the like, to pick one or more actors.

8. The client initiates a request of picking the actor after receiving a confirmation.

9. The server performs operations such as background matting and program clip capturing (a complete program or a program with a certain duration can be intelligently determined) on the actor.

10. The server delivers processed information to the client.

11. The client displays that the actor flies from the program into an operation dock, and plays content according to a certain rule, and the client can present display, playback, and the like of a plurality of actors.

12. The viewer may perform a related operation on a single actor or a plurality of actors in the operation dock.

The several diagrams of interaction procedures listed above are only simple examples. Other related interaction manners are also applicable to the exemplary embodiments of this disclosure. Details are not described herein again.

Exemplary embodiments of this disclosure provide a video playback method and apparatus, an electronic device, and a storage medium. In this disclosure, a viewer may trigger an object recognition operation on video content that has been displayed or that has not been displayed in a video interface. Further, an operation management area is presented in the video interface, at least one recognized recognition object is presented in the area, and a video clip corresponding to each recognition object is played according to a set rule. These video clips are captured from the video content and has environmental background information removed and only information of the corresponding recognition object retained. In this way, the viewer can view clips of one or more favorite recognition objects simultaneously through the operation management area. It can be learned that the video playback method provided in this disclosure is simple to operate. The viewer only needs to trigger an object recognition operation based on at least one piece of video content in the video interface to capture a corresponding video clip and watch the video clip, and neither needs to crop videos nor needs to frequently make searches and repeat the same operation. In this way, the viewer can quickly collect favorite recognition objects and corresponding video clips in a plurality of videos conveniently, which is convenient for the viewer to quickly collect content that the viewer is interested in. Therefore, through the technical solutions of the exemplary embodiments of this disclosure, in one aspect, consumption of device resources and network resources caused by a user frequently searching for clips corresponding to recognition objects is avoided. In another aspect, through simple operations, the user can quickly collect favorite recognition objects and corresponding video clips in a plurality of videos conveniently, thereby improving the efficiency of human-computer interaction.

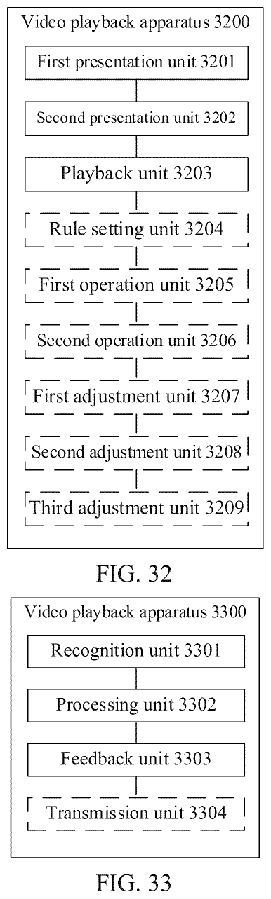

Based on the same inventive concept, exemplary embodiments of this disclosure further provide a video playback apparatus. FIG. 32 is a schematic structural diagram of a video playback apparatus 3200. The apparatus may include:
a first presentation unit 3201, configured to present a video interface, the video interface being configured for displaying at least one piece of video content;
a second presentation unit 3202, configured to present at least one recognized recognition object in an operation management area of the video interface in response to an object recognition operation triggered for the at least one piece of video content, each recognition object corresponding to one video clip, each video clip being a video clip captured from the corresponding video content and having environmental background information removed and the corresponding recognition object retained; and
a playback unit 3203, configured to play at least one video clip in the operation management area according to a set of playback rules a set of playback rules.

In some exemplary embodiments, the second presentation unit 3202 is further configured to:
present, in the operation management area in response to an object recognition operation triggered for first video content currently played on the video interface, at least one recognition object recognized from a current playback picture of the first video content; or
present, in the operation management area in response to an object recognition operation triggered for the video interface, at least one recognition object recognized from second video content, each piece of second video content being video content that is in a content library associated with the video interface and meets an automatic recognition rule.

In some exemplary embodiments, the second presentation unit 3202 is further configured to:
perform the object recognition operation in response to a preset operation performed on a target object in the current playback picture, and present the recognized recognition object in the operation management area; or
perform the object recognition operation in response to a triggering operation on a picture recognition control at a related position of the first video content, and present the at least one recognition object in the current playback picture in the operation management area.

In some exemplary embodiments, the second presentation unit 3202 is further configured to:
present, in response to an object recognition operation triggered for the video interface, prompt information of a recognition result of the object recognition operation in the video interface through an incompletely expanded operation management area; and
present, in response to an expansion operation on the operation management area, the at least one recognition object recognized from the second video content.

In some exemplary embodiments, the second presentation unit 3202 is further configured to:
before the at least one recognition object recognized from the current playback picture of the first video content is presented in the operation management area in response to the object recognition operation triggered for the first video content currently played on the video interface, pause playback of the first video content in the video interface, and present identifier information of recognized recognition objects in the current playback picture.

In some exemplary embodiments, the second presentation unit 3202 is further configured to:
present, in response to confirmation operations on recognition objects in the recognized at least one recognition object, animation effects of the recognition objects moving to the operation management area, and display the recognition objects in the operation management area.

In some exemplary embodiments, the second presentation unit 3202 is further configured to:
display a rule setting interface before the at least one recognition object recognized from the specified video content is presented in the operation management area in response to the object recognition operation triggered for the video interface; and
acquire, in response to an input operation on the rule setting interface, the automatic recognition rule inputted through the rule setting interface.

In some exemplary embodiments, the apparatus further includes:
a rule setting unit 3204, configured to present at least one playback setting option in response to a playback setting operation triggered for the operation management area; and
play, in the operation management area in response to a selection operation on a target option in the at least one playback setting option based on a playback rule corresponding to the target option, a video clip matching the playback rule.

In some exemplary embodiments, the apparatus further includes:
a first operation unit 3205, configured to perform, in response to a first specified operation triggered for at least one recognition object in the operation management area, a corresponding processing logic on a video clip corresponding to the at least one recognition object,
the first specified operation being at least one of a playback control operation and a content processing operation on a video clip.

In some exemplary embodiments, the first operation unit 3205 is further configured to:
present, in response to management operations triggered for recognition objects in the operation management area, at least one first operation control on each of the recognition objects; and
perform, in response to the first specified operation triggered for any first operation control in the at least one first operation control, the corresponding processing logic on a video clip of a specified recognition object corresponding to the first operation control.

In some exemplary embodiments, if the first specified operation is a program return operation in the content processing operation, the first operation unit 3205 is further configured to:
jump from the operation management area to the video interface based on the program return operation, and continue to play video content to which the video clip corresponding to the recognition object corresponding to the first operation control belongs in the video interface.

In some exemplary embodiments, the apparatus further includes:
a second operation unit 3206, configured to present a collection interface in response to a collection viewing operation triggered based on the operation management area, the collection interface displaying at least one collected recognition object and a corresponding video clip.

In some exemplary embodiments, the second operation unit 3206 is further configured to:
perform, in response to a second specified operation triggered for any collected recognition object in the at least one collected recognition object in the collection interface, a corresponding processing logic on a video clip corresponding to the collected recognition object,
the second specified operation being at least one of a playback control operation and a content processing operation on a video clip.

In some exemplary embodiments, the collection interface further includes a second operation control related to collected recognition objects, the second specified operation being a program return operation, and the second operation unit 3206 is further configured to:
jump from the collection interface to the video interface in response to the program return operation triggered for the second operation control related to the collected recognition object, and continue to play video content to which the video clip corresponding to the collected recognition object belongs in the video interface.

In some exemplary embodiments, the apparatus further includes:
a first adjustment unit 3207, configured to: in response to a swipe operation triggered based on the operation management area, swipe and view recognition objects and corresponding video clips in the operation management area.

In some exemplary embodiments, the apparatus further includes:
a second adjustment unit 3208, configured to: in response to a position adjustment operation on at least one specified recognition object in the operation management area, update an arrangement order of the at least one specified recognition object in the operation management area.

In some exemplary embodiments, the apparatus further includes:
a third adjustment unit 3209, configured to: in response to a size adjustment operation on at least one specified recognition object in the operation management area, update display sizes of the at least one specified recognition object and a corresponding video clip in the operation management area.

Based on the same inventive concept, exemplary embodiments of this disclosure further provide another video playback apparatus. FIG. 33 is a schematic structural diagram of a video playback apparatus 3300. The apparatus may include:
a recognition unit 3301, configured to: receive an object recognition request triggered for at least one piece of video content, perform an object recognition on the at least one piece of video content, and acquire recognition objects matching the object recognition request, the object recognition request being transmitted by a client in response to an object recognition operation triggered for the at least one piece of video content;
a processing unit 3302, configured to capture video clips with environmental background information removed and the corresponding recognition objects retained in the at least one piece of video content, each recognition object corresponding to one video clip; and
a feedback unit 3303, configured to: transmit the recognition objects and the corresponding video clips to the client to enable the client to present at least one recognized recognition object in an operation management area of a video interface, and play at least one video clip in the operation management area according to a preset playback rule, the video interface being configured for displaying the at least one piece of video content.

In some exemplary embodiments, the feedback unit 3303 is further configured to:
after the recognition unit 3301 acquires the recognition objects matching the object recognition request and before the processing unit 3302 captures video clips with environmental background information removed and the corresponding recognition objects retained in the at least one piece of video content, transmit confirmation information for recognized recognition objects to the client to enable the client to display identifier information of the recognition objects in the operation management area.

In some exemplary embodiments, the processing unit 3302 is further configured to:
in response to receiving a confirmation request returned by the client for one recognition object, capture video clips with the environmental background information removed and the recognition object retained in the corresponding video content,
the confirmation request being transmitted by the client in response to a confirmation operation on the recognition object.

In some exemplary embodiments, if the object recognition request includes an automatic recognition rule uploaded by the client, the recognition unit 3301 is further configured to:
select, based on the automatic recognition rule from a content library associated with the video interface, video content meeting the automatic recognition rule; and
perform an object recognition on the selected video content, and acquiring a recognition object matching the automatic recognition rule.

In some exemplary embodiments, the feedback unit 3303 is further configured to:
transmit the recognition objects and the corresponding video clips to the client according to a specified order, the specified order being associated with the automatic recognition rule.

In some exemplary embodiments, the apparatus further includes:
a transmission unit 3304, configured to receive a program return request transmitted by the client for a specified video clip;
recognize a playback position associated with the specified video clip based on historical request data of the specified video clip; and
feed back the playback position to the client to enable the client to continue to play video content to which the specified video clip belongs in the video interface based on the playback position.

In this disclosure, a viewer may trigger an object recognition operation on video content that has been displayed or that has not been displayed in a video interface. Further, an operation management area is presented in the video interface, at least one recognized recognition object is presented in the area, and a video clip corresponding to each recognition object is played according to a set rule. These video clips are captured from the video content and has environmental background information removed and only information of the corresponding recognition object retained. In this way, the viewer can view clips of one or more favorite recognition objects simultaneously through the operation management area. It can be learned that the video playback method provided in this disclosure is simple to operate. The viewer only needs to trigger an object recognition operation based on at least one piece of video content in the video interface to capture a corresponding video clip and watch the video clip, and neither needs to crop videos nor needs to frequently make searches and repeat the same operation. In this way, the viewer can quickly collect favorite recognition objects and corresponding video clips in a plurality of programs conveniently, which is convenient for the viewer to quickly collect content that the viewer is interested in. Therefore, through the technical solutions of the exemplary embodiments of this disclosure, in one aspect, consumption of device resources and network resources caused by a user frequently searching for clips corresponding to recognition objects is avoided. In another aspect, through simple operations, the user can quickly collect favorite recognition objects and corresponding video clips in a plurality of videos conveniently, thereby improving the efficiency of human-computer interaction.

For ease of description, the foregoing parts are divided into modules (or units) according to functions and described separately. Certainly, during implementation of this disclosure, functions of the modules (or units) may be implemented in the same one or more pieces of software or hardware.

After the video playback method and apparatus according to exemplary implementations of this disclosure are described, next, an electronic device according to another exemplary implementation of this disclosure is described.

A person skilled in the art can understand that various aspects of this disclosure may be implemented as systems, methods, or computer program products. Therefore, each aspect of this disclosure may be specifically implemented in the following forms, that is, the implementation form of complete hardware, complete software (including firmware and micro code), or a combination of hardware and software, which may be uniformly referred to as “circuit”, “module”, or “system” herein.

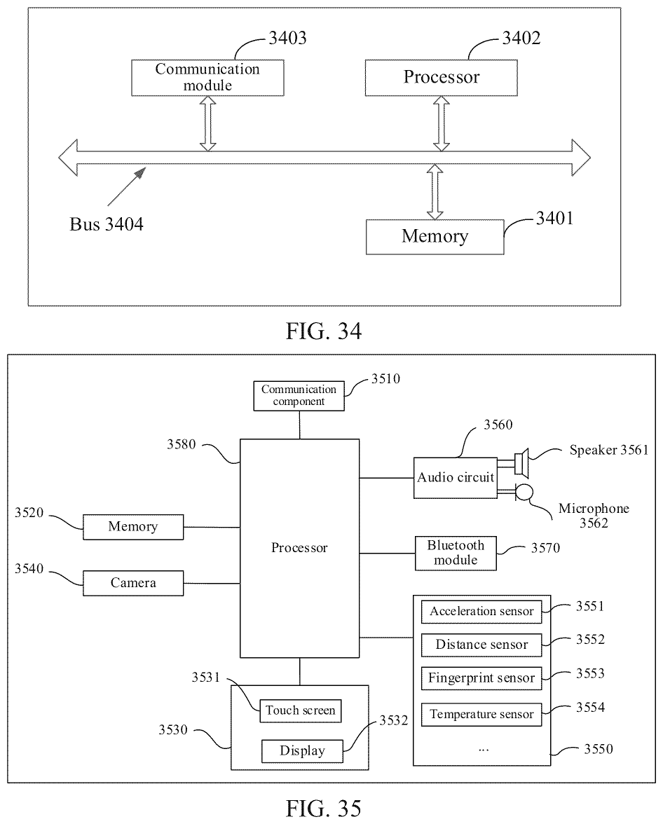

Based on the same inventive concept as the foregoing method embodiments, exemplary embodiments of this disclosure further provide an electronic device. In an exemplary embodiment, the electronic device may be a server, for example, the server 120 shown in FIG. 1. In this exemplary embodiment, the structure of the electronic device may be shown in FIG. 34, including a memory 3401, a communication module 3403, and one or more processors 3402.

The memory 3401 is configured to store a computer program executed by the processor 3402. The memory 3401 may mainly include a program storage area and a data storage area. The program storage area may store an operating system, a program required to run an instant messaging function, or the like. The data storage area may store various instant messaging information, an operation instruction set, and the like.

The memory 3401 may be a volatile memory, for example, a random-access memory (RAM). Alternatively, the memory 3401 may be a non-volatile memory, such as a read-only memory, a flash memory, a hard disk drive (HDD), or a solid-state drive (SSD). Alternatively, the memory 3401 is any other medium that can be used to carry or store expected a computer program having instructions or data structure form and that can be accessed by a computer, but is not limited thereto. The memory 3401 may be a combination of the foregoing memories.

The processor 3402 may include one or more central processing units (CPUs), a digital processing unit, or the like. The processor 3402 is configured to invoke a computer program stored in the memory 3401 to implement the foregoing video playback method.

The communication module 3403 is configured to communicate with a terminal device and another server.

In this exemplary embodiment of this disclosure, a specific connection medium among the memory 3401, the communication module 3403, and the processor 3402 is not limited. In this exemplary embodiment of this disclosure, in FIG. 34, the memory 3401 and the processor 3402 are connected to each other through a bus 3404. The bus 3404 is described by using a bold line in FIG. 34. A manner of connection between other components is only schematically described, but is not used as a limitation. The bus 3404 may be classified into an address bus, a data bus, a control bus, and the like. For ease of description, the bus in FIG. 34 is described by using only one bold line, but which does not describe that there is only one bus or one type of bus.

The memory 3401 has a computer storage medium stored therein. The computer storage medium has computer-executable instructions stored therein. The computer-executable instructions are configured for implementing the video playback method in the exemplary embodiments of this disclosure. The processor 3402 is configured to perform the foregoing video playback method, as shown in FIG. 25.

In another exemplary embodiment, the electronic device may be another electronic device, for example, the server 110 shown in FIG. 1. In this exemplary embodiment, the structure of the electronic device may be shown in FIG. 35, including components such as a communication component 3510, a memory 3520, a display unit 3530, a camera 3540, a sensor 3550, an audio circuit 3560, a Bluetooth module 3570, and a processor 3580.

The communication component 3510 is configured to communicate with the server. In some exemplary embodiments, a circuit Wireless Fidelity (Wi-Fi) module may be included. The Wi-Fi module belongs to a short-range wireless transmission technology. The electronic device can assist a user in transmitting and receiving information through the Wi-Fi module.

The memory 3520 may be configured to store a software program and data. The processor 3580 runs the software program or data stored in the memory 3520, to implement various functions and data processing of the terminal divide 110. The memory 3520 may include a high speed random access memory, and may further include a non-volatile memory, such as at least one magnetic disk storage device, a flash storage device or other non-volatile solid state storage devices. The memory 3520 stores an operating system that enables the terminal device 110 to run. In this disclosure, the memory 3520 may store an operating system and various application programs, and may further store a computer program for performing the video playback method in the exemplary embodiments of this disclosure.

The display unit 3530 may be further configured to display information entered by the user or information provided to the user and a graphical user interface (GUI) of various menus of the terminal device 110. Specifically, the display unit 3530 may include a display screen 3532 disposed on a front surface of the terminal device 110. The display screen 3532 may be configured in the form of a liquid crystal display, a light-emitting diode, or the like. The display unit 3530 may be configured to display a video interface, an operation management area, a collection interface, a rule setting interface, and the like in the exemplary embodiments of this disclosure.

The display unit 3530 may be further configured to receive entered numeric or character information, and generate a signal input related to user settings and functional control of the terminal device 110. Specifically, the display unit 3530 may include a touch screen 3531 disposed on the front surface of the terminal device 110. A touch operation, for example, tapping a button and long pressing a screen, by a user on or near the touch screen may be collected.

The touch screen 3531 may be overlaid on the display screen 3532, or the touch screen 3531 and the display screen 3532 may be integrated to implement input and output functions of the terminal device 110, and may be referred to as a touch display screen after the integration. In this disclosure, the display unit 3530 may display an application program and corresponding operations.

The camera 3540 may be configured to capture a still image, and the user may post an image shot by the camera 3540 through the application. One or more cameras 3540 may be used. An optical image of an object is generated through the lens, and is projected onto the photosensitive element. The photosensitive element may be a charge coupled device (CCD) or a complementary metal-oxide-semiconductor (CMOS) photoelectric transistor. The photosensitive element converts an optical signal into an electrical signal, and then transmits the electrical signal to the processor 3580 for converting the electrical signal into a digital image signal.

The terminal device may further include at least one sensor 3550, for example, an acceleration sensor 3551, a distance sensor 3552, a fingerprint sensor 3553, and a temperature sensor 3554. The terminal device may be further configured with other sensors such as a gyroscope, a barometer, a hygrometer, a thermometer, an infrared sensor, a light sensor, and a motion sensor.

The audio circuit 3560, a speaker 3561, and a microphone 3562 may provide audio interfaces between the user and the terminal device 110. The audio circuit 3560 may convert received audio data into an electrical signal and transmit the electrical signal to the speaker 3561. The speaker 3561 converts the electrical signal into a sound signal and outputs the sound signal. The terminal device 110 may further be configured with a volume button, configured to adjust the volume of a sound signal. According to another aspect, the microphone 3562 converts a collected sound signal into an electrical signal. After receiving the electrical signal, the audio circuit 3560 converts the electrical signal into audio data, and then outputs the audio data to, for example, another terminal divide 110 through the communication component 3510, or outputs the audio data to the memory 3520 for further processing.

The Bluetooth module 3570 is configured to perform information interaction with another Bluetooth device having a Bluetooth module through a Bluetooth protocol. For example, the terminal device may establish, through the Bluetooth module 3570, a Bluetooth connection with a wearable electronic device (for example, a smartwatch) also equipped with a Bluetooth module, to perform data interaction.

The processor 3580 is a control center of the terminal divide, and connects to various parts of the terminal by using various interfaces and lines. By running or executing the software program stored in the memory 3520, and invoking data stored in the memory 3520, the processor performs various functions and data processing of the terminal divide. In some exemplary embodiments, the processor 3580 may include the one or more processing units. In some exemplary embodiments, the processor 3580 may further integrate an application processor and a baseband processor. The application processor mainly processes an operating system, a UI, an application program, and the like. The baseband processor mainly processes wireless communication. The baseband processor may alternatively not be integrated in the processor 3580. The processor 3580 in this disclosure may run an operating system, an application program, user interface display, touch response, and the video playback method in the exemplary embodiments of this disclosure. In addition, the processor 3580 is coupled to the display unit 3530.

In some exemplary implementations, each aspect of the video playback method provided in this disclosure may be further implemented in a form of a program product including a computer program. When the program product is run on an electronic device, the computer program is configured to enable the electronic device to perform operations of the video playback method according to the various exemplary implementations of this disclosure described above in the specification. For example, the electronic device can perform the operations shown in FIG. 2 to FIG. 25.

The program product may be any combination of one or more readable mediums. The readable medium may be a computer-readable signal medium or a computer-readable storage medium. The readable storage medium may be, for example but not limited to, an electrical, magnetic, optical, electromagnetic, infrared, or semiconductor system, apparatus, or device, or any combination thereof. More specific examples (non-exhaustive list) of the readable storage medium may include: an electrical connection having one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination thereof.

The program product according to an implementation of this disclosure may use a CD-ROM, include a computer program, and may be run on the electronic device. However, the program product of this disclosure is not limited to this. In this specification, the readable storage medium may be any tangible medium including or storing a program, and the program may be used by or in combination with an command execution system, apparatus, or device.

The readable signal medium may include a data signal propagated in a baseband or as part of a carrier, and stores a readable computer program. The data signal propagated in such a way may assume a plurality of forms, including, but not limited to, an electromagnetic signal, an optical signal, or any appropriate combination thereof. The readable signal medium may alternatively be any readable medium other than the readable storage medium. The readable medium may be configured to transmit, propagate, or transmit a program configured to be used by or in combination with a command execution system, apparatus, or device.

The program included in the computer-readable medium may be transmitted by using any suitable medium, including but not limited to: a wireless medium, a wire, an optical fiber, an RF, or the like, or any suitable combination thereof.

The computer program configured for executing the operations of this disclosure may be written by using one or more programming languages or a combination thereof. The programming languages include an object-oriented programming language such as Java and C++, and also include a conventional procedural programming language such as “C” or similar programming languages. The computer program may be completely executed on a user electronic device, partially executed on user electronic device, executed as an independent software package, partially executed on a user electronic device and partially executed on a remote electronic device, or completely executed on a remote electronic device or server. In a case involving a remote electronic device, the remote computing device may be connected to a user electronic device through any type of network including a LAN or a WAN, or may be connected to an external electronic device (for example, through the Internet by using an Internet service provider).

Although several units or subunits of the apparatus are mentioned in detailed description above, such division is merely an example but not mandatory. In fact, according to the implementations of this disclosure, features and functions of two or more units described above may be specified in one unit. On the contrary, the features or functions of one unit described above may further be divided and specified by a plurality of units.

In addition, although the operations of the method in the exemplary embodiments of this disclosure are described in a specific order in the accompanying drawings. This does not require or imply that the operations have to be performed in the specific order, or all the operations shown have to be performed to achieve an expected result. Additionally or alternatively, some operations may be omitted, and a plurality of operations are combined into one operation to be performed, and/or one operation is divided into a plurality of operations to be performed.

A person skilled in the art is to understand that the exemplary embodiments of this disclosure may be provided as a method, a system, or a computer program product. Therefore, this disclosure may take the form of total hardware embodiments, total software embodiments, or embodiments combining software and hardware. In addition, this disclosure may use a form of a computer program product that is implemented on one or more computer-usable storage media (including but not limited to a disk memory, a CD-ROM, an optical memory, and the like) that include computer-usable computer program.

This disclosure is described with reference to flowcharts and/or block diagrams of the method, the device (system), and the computer program product according to the exemplary embodiments of this disclosure. Computer program commands can implement each procedure and/or block in the flowcharts and/or block diagrams and a combination of procedures and/or blocks in the flowcharts and/or block diagrams. These computer program commands may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using commands executed by the general-purpose computer or the processor of another programmable data processing device.

These computer program commands may also be stored in a computer readable memory that can guide a computer or another programmable data processing device to work in a specified manner, so that the commands stored in the computer readable memory generate a product including a command apparatus. The command apparatus implements functions specified in one or more procedures in the flowcharts and/or one or more blocks in the block diagrams.

The computer program commands may also be loaded onto a computer or another programmable data processing device, so that a series of operations are performed on the computer or the another programmable device, thereby generating computer-implemented processing. Therefore, the commands executed on the computer or the another programmable device provide operations for implementing a specific function in one or more processes in the flowcharts and/or in one or more blocks in the block diagrams.

Although the foregoing exemplary embodiments of this disclosure have been described, once persons skilled in the art learn a basic creative concept, they can make other changes and modifications to these exemplary embodiments. Therefore, the following claims are intended to cover the foregoing exemplary embodiments and all changes and modifications falling within the scope of this disclosure.

Certainly, a person skilled in the art can make various modifications and variations to this disclosure without departing from the spirit and scope of this disclosure. In this case, if the modifications and variations made to this disclosure fall within the scope of the claims of this disclosure and their equivalent technologies, this disclosure is intended to include these modifications and variations.

What is claimed is:

1. A video playback method performed by a terminal device, the method comprising:
presenting a video interface, the video interface being configured for displaying at least one piece of video content;
presenting at least one recognized recognition object in an operation management area of the video interface in response to an object recognition operation triggered for the at least one piece of video content, each recognition object corresponding to one video clip, each video clip being a video clip captured from the video content and having environmental background information removed and the recognition object retained; and
playing at least one video clip in the operation management area according to a set of playback rules.

2. The method according to claim 1, wherein presenting at least one recognized recognition object in an operation management area of the video interface in response to an object recognition operation triggered for the at least one piece of video content comprises:
presenting, in the operation management area in response to an object recognition operation triggered for a first video content currently played on the video interface, at least one recognition object recognized from a current playback picture of the first video content; or
presenting, in the operation management area in response to an object recognition operation triggered for the video interface, at least one recognition object recognized from a second video content, each piece of the second video content being video content that is in a content library associated with the video interface and meets an automatic recognition rule.

3. The method according to claim 2, wherein the presenting, in the operation management area in response to an object recognition operation triggered for a first video content currently played on the video interface, at least one recognition object recognized from a current playback picture of the first video content comprises:
performing the object recognition operation in response to a preset operation performed on a target object in the current playback picture, and presenting the recognized recognition object in the operation management area; or
performing the object recognition operation in response to a triggering operation on a picture recognition control at a related position of the first video content, and presenting the at least one recognition object in the current playback picture in the operation management area.

4. The method according to claim 2, wherein before the presenting, in the operation management area in response to an object recognition operation triggered for the video interface, at least one recognition object recognized from a second video content, the method further comprises:
presenting prompt information of a recognition result of the object recognition operation in the video interface through an incompletely expanded operation management area; and
the presenting, in the operation management area, at least one recognition object recognized from a second video content comprises:
presenting, in response to an expansion operation on the operation management area in an expanded operation management area, the at least one recognition object recognized from the second video content.

5. The method according to claim 2, wherein before the presenting, in the operation management area in response to an object recognition operation triggered for first video content currently played on the video interface, at least one recognition object recognized from a current playback picture of the first video content, the method further comprises:
pausing playback of the first video content in the video interface, and presenting identifier information of recognized recognition objects in the current playback picture; and
presenting, in response to confirmation operations on recognition objects in the recognized at least one recognition object, animation effects of the recognition objects moving to the operation management area, and displaying the recognition objects in the operation management area.

6. The method according to claim 2, wherein before the presenting, in the operation management area in response to an object recognition operation triggered for the video interface, at least one recognition object recognized from a second video content, the method further comprises:
presenting a rule setting interface; and
acquiring, in response to an input operation on the rule setting interface, an automatic recognition rule inputted through the rule setting interface.

7. The method according to claim 1, wherein the method further comprises:
presenting at least one playback setting option in response to a playback setting operation triggered for the operation management area; and
playing, in the operation management area in response to a selection operation on a target option in the at least one playback setting option based on a playback rule corresponding to the target option, a video clip matching the playback rule.

8. The method according to claim 1, wherein the method further comprises:
performing, in response to a first specified operation triggered for at least one recognition object in the operation management area, a corresponding processing logic on a video clip corresponding to the at least one recognized recognition object, the first specified operation being at least one of a playback control operation or a content processing operation on a video clip.

9. The method according to claim 8, wherein the performing, in response to a first specified operation triggered for at least one recognition object in the operation management area, a corresponding processing logic on a video clip corresponding to the at least one recognized recognition object comprises:
presenting, in response to management operations triggered for recognition objects in the operation management area, at least one first operation control on each of the recognition objects; and
performing, in response to the first specified operation triggered for any first operation control in the at least one first operation control, the corresponding processing logic on a video clip of a recognition object corresponding to the first operation control.

10. The method according to claim 9, wherein if the first specified operation is a program return operation in the content processing operation, the performing, in response to the first specified operation triggered for any first operation control in the at least one first operation control, the corresponding processing logic on a video clip of a recognition object corresponding to the first operation control comprises:
jumping from the operation management area to the video interface based on the program return operation; and
continuing to play video content to which the video clip corresponding to the recognition object corresponding to the first operation control belongs in the video interface.

11. The method according to claim 1, wherein the method further comprises:
presenting a collection interface in response to a collection viewing operation triggered based on the operation management area, the collection interface displaying at least one collected recognition object and a corresponding video clip; and
performing, in response to a second specified operation triggered for any collected recognition object in the at least one collected recognition object in the collection interface, a corresponding processing logic on a video clip corresponding to the collected recognition object, the second specified operation being at least one of a playback control operation or a content processing operation on a video clip.

12. The method according to claim 11, wherein the collection interface further comprises a second operation control related to collected recognition objects, the second specified operation being a program return operation; and
the performing, in response to a second specified operation triggered for any collected recognition object in the at least one collected recognition object in the collection interface, a corresponding processing logic on a video clip corresponding to the collected recognition object comprises:
jumping from the collection interface to a video interface in response to the program return operation triggered for the second operation control related to the collected recognition object, and continuing to play video content to which the video clip corresponding to the collected recognition object belongs in the video interface.

13. A video playback method performed by a server, the method comprising:
receiving an object recognition request triggered for at least one piece of video content;
performing an object recognition on the at least one piece of video content;
acquiring recognition objects matching the object recognition request, the object recognition request being transmitted by a client in response to an object recognition operation triggered for the at least one piece of video content;
capturing video clips with environmental background information removed and the corresponding recognition objects retained in the at least one piece of video content, each recognition object corresponding to one video clip; and
transmitting the recognition objects and the corresponding video clips to the client to enable the client to present at least one recognized recognition object in an operation management area of a video interface, and playing at least one video clip in the operation management area according to a preset playback rule, the video interface being configured for displaying the at least one piece of video content.

14. The method according to claim 13, wherein after the acquiring and before the capturing, the method further comprises:
transmitting confirmation information for recognized recognition objects to the client to enable the client to display identifier information of the recognized recognition objects in the operation management area.

15. The method according to claim 13, wherein the capturing comprises:
in response to receiving a confirmation request returned by the client for one recognition object, capturing video clips with the environmental background information removed and the recognition object retained in the video content, the confirmation request being transmitted by the client in response to a confirmation operation on the recognition object.

16. The method according to claim 13, wherein if the object recognition request comprises an automatic recognition rule uploaded by the client, the performing and acquiring comprise:
selecting, based on the automatic recognition rule from a content library associated with the video interface, video content meeting the automatic recognition rule; and
performing an object recognition on the selected video content, and acquiring a recognition object matching the automatic recognition rule.

17. The method according to claim 16, wherein the transmitting the recognition objects and the corresponding video clips to the client comprises:
transmitting the recognition objects and the corresponding video clips to the client according to a specified order, the specified order being associated with the automatic recognition rule.

18. The method according to claim 13, where the method further includes:
receiving a program return request transmitted by the client for a specified video clip;
recognizing a playback position associated with the specified video clip based on historical request data of the specified video clip; and
feeding back the playback position to the client to enable the client to continue to play video content to which the specified video clip belongs in the video interface based on the playback position.

19. A video playback apparatus, comprising a memory for storing instructions and at least one processor for executing the instructions to perform the steps of claim 13.

20. A video playback apparatus, comprising a memory for storing instructions and at least one processor for executing the instructions to:
present a video interface, the video interface being configured for displaying at least one piece of video content;
present at least one recognized recognition object in an operation management area of the video interface in response to an object recognition operation triggered for the at least one piece of video content, each recognition object corresponding to one video clip, each video clip being a video clip captured from the video content and having environmental background information removed and the recognition object retained; and
play at least one video clip in the operation management area according to a set of playback rules.
